(19) United States
(12) Patent Application Publication
(10) Pub. No.: US 2020/0186407 A1
(43) Pub. Date: Jun. 11, 2020

(54) COMMUNICATION TERMINAL, IMAGE NETWORK SYSTEM, DISPLAY METHOD, AND PROGRAM

(71) Applicants: Kenichiro MORITA, Tokyo (JP); Hidekuni ANNAKA, Saitama (JP); Takeshi HOMMA, Kanagawa (JP); Takuya SONEDA, Kanagawa (JP); Tomonori AIKAWA, Kanagawa (JP); Hideki SHIRO, Kanagawa (JP); Takafumi TAKEDA, Tokyo (JP)

(72) Inventors: Kenichiro MORITA, Tokyo (JP); Hidekuni ANNAKA, Saitama (JP); Takeshi HOMMA, Kanagawa (JP); Takuya SONEDA, Kanagawa (JP); Tomonori AIKAWA, Kanagawa (JP); Hideki SHIRO, Kanagawa (JP); Takafumi TAKEDA, Tokyo (JP)

(21) Appl. No.: 16/699,340

(22) Filed: Nov. 29, 2019

(30) Foreign Application Priority Data
Nov. 30, 2018 (JP) 2018-224424
Sep. 30, 2019 (JP) 2019-178182

(51) Int. Cl. H04L 29/06; H04N 5/232

(52) U.S. Cl. CPC H04L 29/06435; H04L 29/06027; H04L 65/1059; H04N 5/23238; H04L 65/1089; H04L 65/4053; H04N 5/23206; H04L 65/1069

(57) ABSTRACT

A communication terminal is provided that is configured to display a first image of a first predetermined area is a whole image shared with another communication terminal. The communication terminal includes processing circuitry configured to receive predetermined area information indicating the second predetermined area transmitted by another communication terminal displaying the second predetermined area image of the second predetermined area in the whole image; and control displaying of the second predetermined area image indicated by the received predetermined area information based on an operation status with respect to the first predetermined area image when the predetermined area information is received.

### CROSS-REFERENCE TO RELATED APPLICATIONS

This patent application is based on and claims priority pursuant to 35 U.S.C. § 119(a) to Japanese Patent Application No. 2018-224424, filed on Nov. 30, 2018, and Japanese Patent Application No. 2019-178182, filed on Sep. 30, 2019, in the Japan Patent Office, the entire disclosure of which is incorporated herein by reference.

### BACKGROUND

### Technical Field

The present disclosure relates to a communication terminal, an image network system, a display method, and a program.

### Description of the Related Art

A system is now in widespread use, allowing users to watch an image of a remote place via a communication network such as the Internet.

For example, as to a network system comprising a network camera and viewer, the network camera is configured to distribute a captured image to a plurality of viewers in real time and to accept a control request from a plurality of viewers having control at the same time.

### SUMMARY

A communication terminal is capable of displaying a first predetermined area image of a first predetermined area is a whole image shared with another communication terminal.

The communication terminal includes processing circuitry configured to receive a predetermined area information indicating a second predetermined area transmitted by another communication terminal displaying a second predetermined area image of the second predetermined area in the whole image; and control displaying of the second predetermined area image indicated by the received predetermined area information based on an operation status with respect to the first predetermined area image when the predetermined area information is received.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A is a left side view of an image capturing device, according to an embodiment of the present disclosure;

FIG. 1B is a front view of the image capturing device of FIG. 1A;

FIG. 1C is a plan view of the image capturing device of FIG. 1A;

FIG. 2 is an illustration of how a user uses the image capturing device, according to an embodiment of the present disclosure;

FIG. 3A is an illustration of a front side of a hemispherical image captured by the image capturing device, according to an embodiment of the present disclosure;

FIG. 3B is an illustration of a back side of a hemispherical image captured by the image capturing device, according to an embodiment of the present disclosure;

FIG. 3C is an illustration of an image captured by the image capturing device represented by Mercator projection, according to an embodiment of the present disclosure;

FIG. 4A is an illustration of a Mercator image covering a sphere, according to an embodiment of the present disclosure;

FIG. 4B is an illustration of a spherical panoramic image, according to an embodiment of the present disclosure;

FIG. 5 is an illustration of relative positions of a virtual camera and a predetermined area in a case where the spherical panoramic image is represented as a three-dimensional sphere, according to an embodiment of the present disclosure;

FIG. 6A is a perspective view of FIG. 5;

FIG. 6B is an illustration of an image of the predetermined area displayed on a display of a communication terminal, according to an embodiment of the present disclosure;

FIG. 7 is a diagram illustrating a relation between predetermined-area information and a predetermined area, according to an embodiment of the present disclosure;

FIG. 8 is a diagram illustrating points in a three-dimensional Euclidean space according to spherical coordinates, according to an embodiment of the present disclosure;

FIG. 9 is a schematic diagram illustrating a configuration of an image communication system, according to an embodiment of the present disclosure;

FIG. 10 is a block diagram illustrating a hardware configuration of the image capturing device, according to an embodiment of the present disclosure;

FIG. 11 is a block diagram illustrating a hardware configuration of a videoconference terminal, according to an embodiment of the present disclosure;

FIG. 12 is a block diagram illustrating a hardware configuration of any one of a communication management system and a personal computer (PC), according to an embodiment of the present disclosure;

FIG. 13 is a block diagram illustrating a hardware configuration of a smartphone, according to an embodiment of the present disclosure;

FIG. 14 is a block diagram illustrating a functional configuration of the image communication system, according to an embodiment of the present disclosure;

FIG. 15 is a block diagram illustrating a functional configuration of the image communication system, according to an embodiment of the present disclosure;

FIG. 16 is a conceptual diagram illustrating an image type management table, according to an embodiment of the present disclosure;

FIG. 17 is a conceptual diagram illustrating an image capturing device management table, according to an embodiment of the present disclosure;

FIG. 18 is a conceptual diagram illustrating a display mode management table, according to an embodiment of the present disclosure;

FIG. 19 is a conceptual diagram illustrating an operate condition management table, according to an embodiment of the present disclosure;

FIG. 20 is a conceptual diagram illustrating a session management table, according to an embodiment of the present disclosure;

FIG. 21 is a conceptual diagram illustrating an image type management table, according to an embodiment of the present disclosure;

FIG. 22 is a sequence diagram illustrating an operation of participating in a specific communication session, according to an embodiment of the present disclosure;

FIG. 23 is an illustration of a session selection screen for selecting a communication session (virtual conference room), according to an embodiment of the present disclosure;

FIG. 24 is a sequence diagram illustrating an operation of managing image type information, according to an embodiment of the present disclosure;

FIG. 25A is an illustration of an example state of video communication when the image capturing device of FIGS. 1A to 1C is not used, according to an embodiment of the present disclosure;

FIG. 25B is an illustration of an example state of video communication when the image capturing device of FIGS. 1A to 1C is used, according to an embodiment of the present disclosure;

FIG. 26 is a sequence diagram illustrating an operation of transmitting image data and sound data in video communication, according to an embodiment of the present disclosure;

FIG. 27A is an illustration of an example of a screen of video communication in one base, in which images corresponding to image data transmitted from the image capturing device of FIGS. 1A to 1C are displayed as they are, without generating the spherical panoramic image and the predetermined-area image, according to an embodiment of the present disclosure;

FIG. 27B is illustration of an example of another screen of the video communication in the one base, in which images are displayed after the spherical panoramic image and the predetermined-area image are generated based on image data transmitted from the image capturing device of FIGS. 1A to 1C, according to an embodiment of the present disclosure;

FIG. 27C is illustration of an example of another screen of the video communication in the one base, in which images are displayed after changing predetermined-area image of FIG. 27B, according to an embodiment of the present disclosure;

FIG. 28 is a flowchart illustrating an operation of input of display status table, according to an embodiment of the present disclosure;

FIG. 29 is a sequence diagram illustrating an operation of sending of predetermined area information, according to an embodiment of the present disclosure;

FIG. 30 is a flowchart illustrating an operation of receiving of predetermined area information, according to an embodiment of the present disclosure;

FIG. 31 is a sequence diagram illustrating an operation of sending of message from sender terminal to destination terminal, according to an embodiment of the present disclosure;

FIG. 32 is a flowchart illustrating an operation after operation state transition, according to an embodiment of the present disclosure;

FIG. 33A is an illustration showing the same display image as FIG. 27 (c) in the base B according to an embodiment of the present disclosure;

FIG. 33B is an illustration showing a state of video communication in the base A and showing with an arrow an imaging area of the base A illustrating at FIG. 33A correspond to the predetermined area image, according to an embodiment of the present disclosure;

FIG. 34A is an illustration showing a display image after a change operation is performed on a predetermined area image showing the state of the base A in FIG. 33A, according to an embodiment of the present disclosure;

FIG. 34B is an illustration showing a state of video communication in the base A and which showed with an arrow an imaging area of the base A illustrating at FIG. 34A correspond to the predetermined area image, according to an embodiment of the present disclosure;

FIG. 35A is an illustration showing a display image including a predetermined area image based on predetermined area information sent from the communication terminal at base A, according to an embodiment of the present disclosure;

FIG. 35B is an illustration showing a state of video communication in the base A and which showed with an arrow an imaging area of the base A illustrating at FIG. 35A correspond to the predetermined area image, according to an embodiment of the present disclosure;

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, embodiments of the present disclosure are described.

### First Embodiment

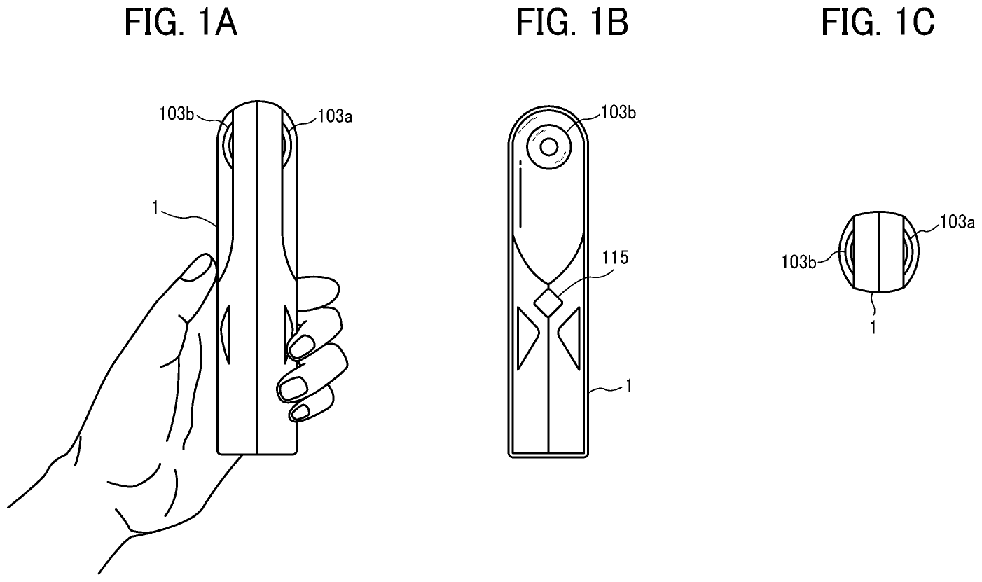

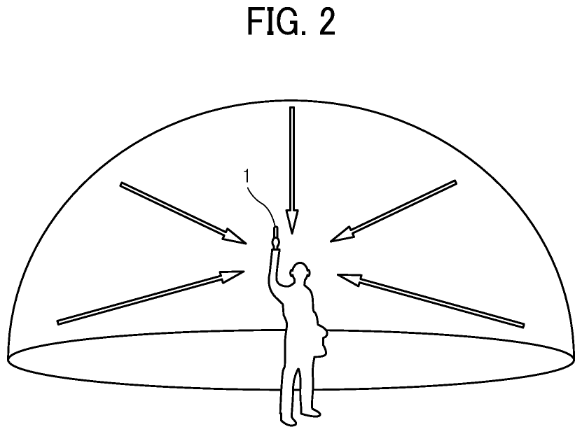

Referring to FIG. 1 (FIGS. 1A to 1C) to FIG. 31, a description is given of generating a spherical panoramic image.

### Overview of Embodiment

<Generation of Spherical Panoramic Image>

Referring to FIG. 1 (FIGS. 1A to 1C) to FIG. 7, a description is given of generating a spherical panoramic image.

First, a description is given of an external view of an image capturing device 1, with reference to FIG. 1A to FIG. 1C. The image capturing device 1 is a digital camera for capturing images from which a spherical image is generated. In one example, the spherical image captured by the image capturing device 1 is a 360-degree spherical panoramic image (full-view spherical image). FIGS. 1A, 1B and 1C are respectively a left side view, a front view, and a plan view (top view) of the image capturing device 1.

As illustrated in FIG. 1A, the image capturing device 1 has a shape such that one can hold it with one hand. Further, as illustrated in FIGS. 1A, 1B, and IC, an imaging element 103a is provided on a front side (anterior side) of an upper section of the image capturing device 1, and an imaging element 103b is provided on a back side (rear side) thereof. These imaging elements (image sensors) 103a and 103b are used in combination with optical members (e.g., fisheye lenses 102a and 102b, described below), each being configured to capture a hemispherical image having an angle of view of 180 degrees or wider. As illustrated in FIG. 1B, the image capturing device 1 further includes an operation unit 115 such as a shutter button on the rear side of the image capturing device 1, which is opposite of the front side of the image capturing device 1.

Next, a description is given of a situation where the image capturing device 1 is used, with reference to FIG. 2. FIG. 2 illustrates an example of how a user uses the image capturing device 1. As illustrated in FIG. 2, for example, the image capturing device 1 is used for capturing objects surrounding a user who is holding the image capturing device 1 in his or her hand. The imaging elements 103a and 103b illustrated in FIGS. 1A to 1C capture the objects surrounding the user to obtain two hemispherical images.

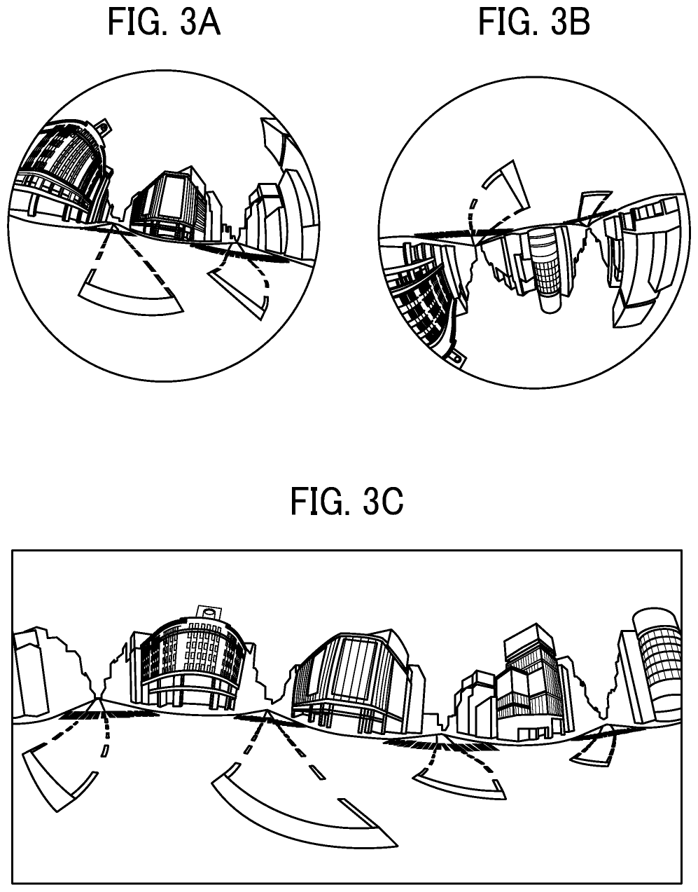

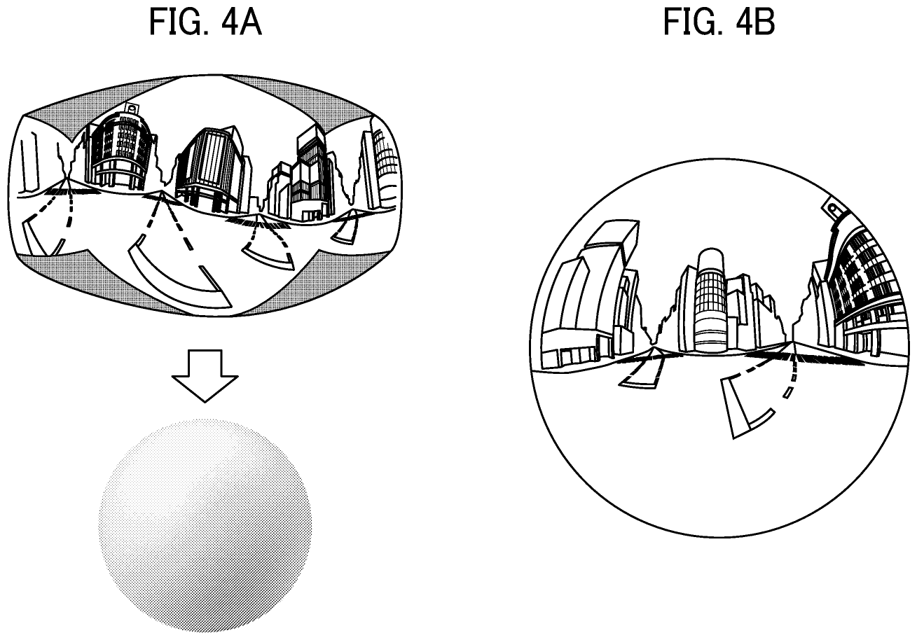

Next, a description is given of an overview of an operation of generating a spherical panoramic image from the images captured by the image capturing device 1, with reference to FIGS. 3A to 3C and FIGS. 4A and 4B. FIG. 3A is a view illustrating a hemispherical image (front side) captured by the image capturing device 1. FIG. 3B is a view illustrating a hemispherical image (back side) captured by the image capturing device 1. FIG. 3C is a view illustrating an image in Mercator projection. The image in Mercator projection as illustrated in FIG. 3C is referred to as a “Mercator image” hereinafter. FIG. 4A is a conceptual diagram illustrating an example of how the Mercator image maps to a surface of a sphere. FIG. 4B is a view illustrating a spherical panoramic image.

As illustrated in FIG. 3A, an image captured by the imaging element 103a is a curved hemispherical image (front side) taken through the fisheye lens 102a described later. In addition, as illustrated in FIG. 3B, an image captured by the imaging element 103b is a curved hemispherical image (back side) taken through the fisheye lens 102b described later. The image capturing device 1 combines one hemispherical image (front side) and the other hemispherical image (back side), which is reversed by 180-degree, to generate the Mercator image as illustrated in FIG. 3C.

The Mercator image is mapped on the sphere surface using Open Graphics Library for Embedded Systems (OpenGL ES) as illustrated in FIG. 4A. This results in generation of the spherical panoramic image as illustrated in FIG. 4B. In other words, the spherical panoramic image is represented as the Mercator image, which corresponds to a surface facing a center of the sphere. OpenGL ES is a graphic library used for visualizing two-dimensional (2D) and three-dimensional (3D) data. The spherical panoramic image is either a still image or a moving image.

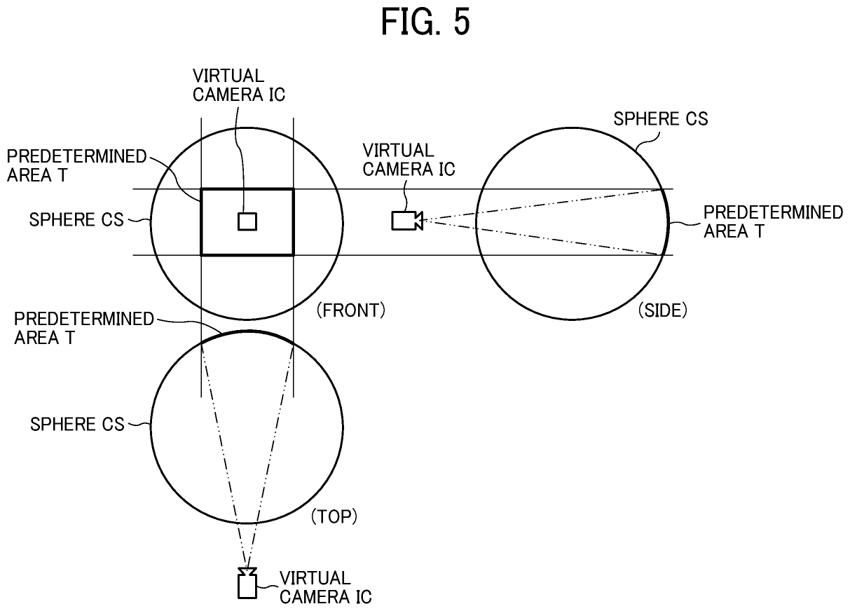

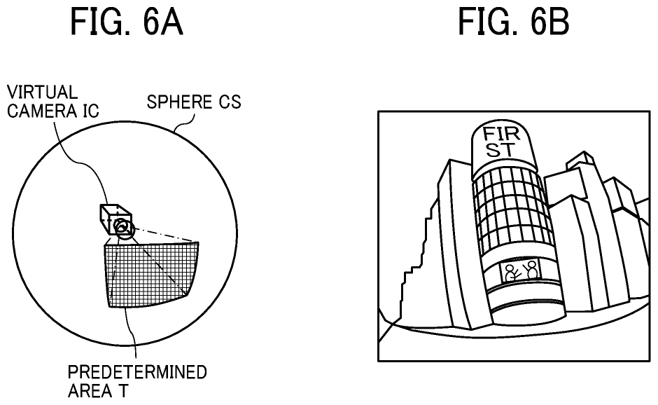

One may feel strange viewing the spherical panoramic image, because the spherical panoramic image is an image mapped to the sphere surface. To resolve this strange feeling, an image of a predetermined area, which is a part of the spherical panoramic image, is displayed as a planar (flat) image having fewer curves. In this disclosure, the image of the predetermined area is referred to as a “predetermined-area image”. Hereinafter, a description is given of displaying the predetermined-area image, with reference to FIG. 5 and FIGS. 6A to 6C.

FIG. 5 is an illustration of a positional relation between a virtual camera IC and the predetermined area T when the spherical panoramic image is represented as a surface area of three-dimensional solid sphere. The virtual camera IC corresponds to a position of a point of view (viewpoint) of a user who is viewing the spherical panoramic image represented as a surface area of the three-dimensional solid sphere CS. FIG. 6A is a perspective view of FIG. 5. FIG. 6B is a view illustrating an example of the predetermined-area image when displayed on a display. In FIG. 6A, the spherical panoramic image illustrated in FIG. 4B is represented as a three-dimensional solid sphere CS. Assuming that the spherical panoramic image is a surface area of the solid sphere CS, the virtual camera IC is outside of the spherical panoramic image as illustrated in FIG. 5. The predetermined area T in the spherical panoramic image is an imaging area of the virtual camera IC. Specifically, the predetermined area T is specified by predetermined-area information indicating an imaging direction and an angle of view of the virtual camera IC in a three-dimensional virtual space containing the spherical panoramic image.

The predetermined-area image, which is an image of the predetermined area T illustrated in FIG. 6A, is displayed as an imaging area of the virtual camera IC on a display, as illustrated in FIG. 6B. FIG. 6B illustrates the predetermined-area image represented by the predetermined-area information (display parameter) that is set by default. Instead of the predetermined area information and the position coordinates of the virtual camera IC, it may be indicated by the imaging area (X, Y, Z) of the virtual camera IC which is the predetermined area T. In the following description of the embodiment, an imaging direction (ea, aa) and an angle of view a of the virtual camera IC are used.

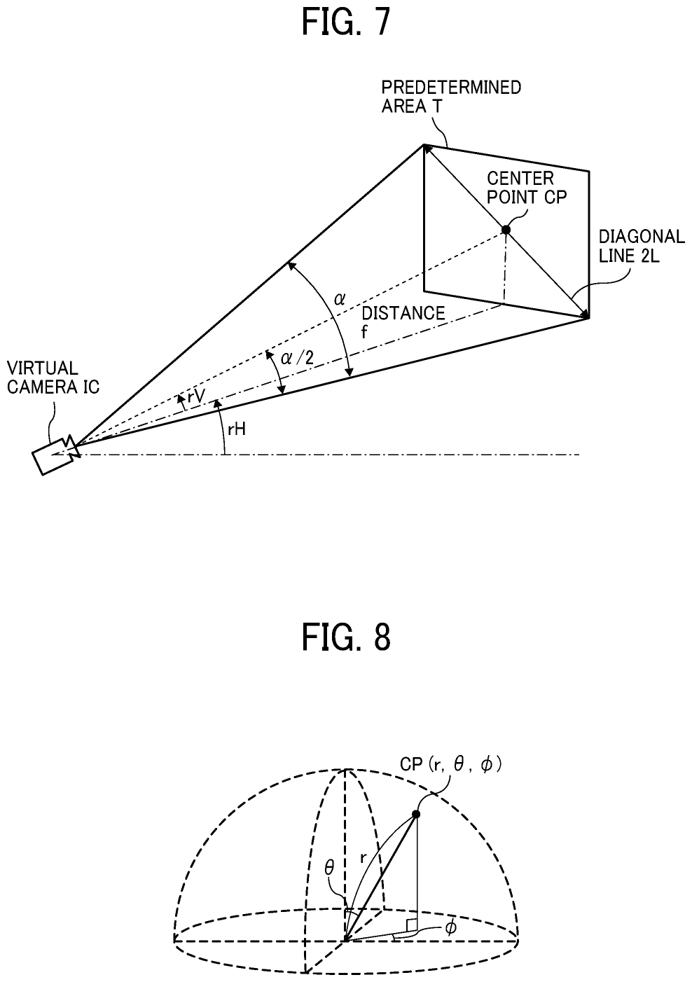

Referring to FIG. 7, a relation between the predetermined-area information and an image of the predetermined area T is described according to the embodiment. FIG. 7 is a view illustrating a relation between the predetermined-area information and the predetermined area T. As illustrated in FIG. 7, “rH” denotes a Horizontal Radian, “rV” denotes a Vertical Radian, and “α” denotes an angle of view, respectively, of the virtual camera IC. The position of the virtual camera IC is adjusted, such that the point of gaze of the virtual camera IC, indicated by the imaging direction (rH, rV), matches the center point CP of the predetermined area T as the imaging area of the virtual camera IC. The predetermined-area image Q is an image of the predetermined area T, in the spherical image CE. Distance “f” denotes a distance from the virtual camera IC to the center point CP of the predetermined area T. L is a distance between the center point CP and a given vertex of the predetermined area T (2L is a diagonal line). In FIG. 7, a trigonometric function equation generally expressed by the following equation 1 is satisfied.

L/f=tan(α/2) (Equation 1)

FIG. 8 is a view illustrating points in a three-dimensional Euclidean space according to spherical coordinates, according to the embodiment. A positional coordinate (r, θ, φ) is given when the center point CP is represented by a spherical polar coordinate system. The positional coordinate (r, θ, φ) represents a moving radius, a polar angle, and an azimuth angle. The moving radius r is a distance from the origin of the three-dimensional virtual space including the spherical panoramic image to the center point CP. Accordingly, the moving radius r is equal to “f”. FIG. 8 illustrates the relation between these items. In the following description of the embodiment, the positional coordinates (r, 0, p) of the virtual camera IC is used.

<Overview of Image Communication System>

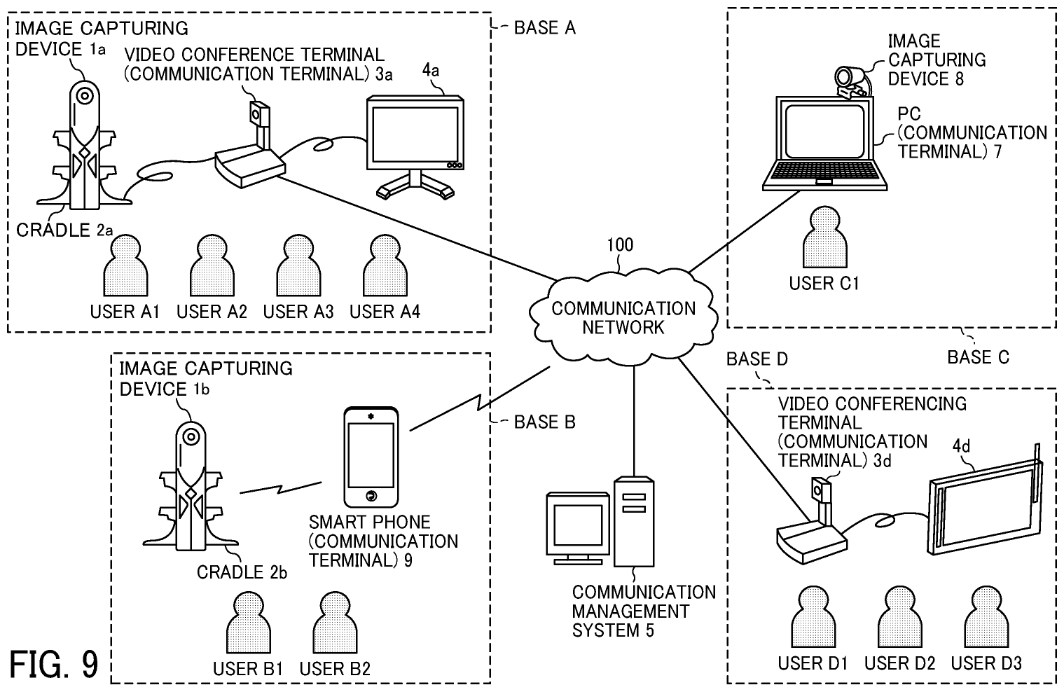

Referring to FIG. 9, an overview of a configuration of an image communication system according to the present embodiment is described. FIG. 9 is a schematic diagram illustrating a configuration of the image communication system according to the present embodiment.

As illustrated in FIG. 9, the image communication system according to the present embodiment includes an image capturing device 1a, an image capturing device 1b, a videoconference terminal 3, a communication management system 5, a personal computer (PC) 7, an image capturing device 8, and a smartphone 9. The videoconference terminal 3, the smartphone 9, and the PC 7 are communicably connected with one another via a communication network 100 such as the Internet. The communication network 100 can be either a wireless network or a wired network.

Each of the image capturing device 1a and the image capturing device 1b is a special digital camera, which captures an image of an object or surroundings such as scenery to obtain two hemispherical images, from which a spherical panoramic image is generated. By contrast, the image capturing device 8 is a general-purpose digital camera that captures an image of an object or surroundings to obtain a general planar image.

The videoconference terminal 3a, 3d is a terminal that is dedicated to videoconferencing. The videoconference terminal 3a, 3b displays an image of video communication (video calling) on each display 4a, 4d, via a wired cable such as a universal serial bus (USB) cable. The videoconference terminal 3a usually captures an image by a camera 312, which is described later. However, when the videoconference terminal 3a is connected to a cradle 2a on which the image capturing device 1a is mounted, the image capturing device 1a is preferentially used. Accordingly, two hemispherical images are obtained, from which a spherical panoramic image is generated. When a wired cable is used for connecting the videoconference terminal 3a and the cradle 2a, the cradle 2a supplies power to the image capturing device 1a and holds the image capturing device 1a in addition to establishing communication between the image capturing device 1a and the videoconference terminal 3a. In the embodiment, the image capturing device 1a, the cradle 2a, the videoconference terminal 3a, and the display 4a are provided in the same base A. In the base A, four users A1, A2, A3 and A4 are participating in video communication. On the other hand, the videoconference terminal 3b and the display 4b are provided in the base D. In the base D, three users D1, D2 and D3 are participating in video communication.

The communication management system 5 manages communication among the videoconference terminal 3a, 3d, the PC 7 and the smartphone 9. Further, the communication management system 5 manages types (a general image type and a special image type) of image data to be exchanged among the videoconference terminal 3, the PC 7 and the smartphone 9. Therefore, the communication management system is also a communication control system. In the embodiment, a special image is a spherical panoramic image, and a general image is a planar image. The communication management system 5 is provided, for example, at a service provider that provides video communication service. In one example, the communication management system 5 is configured as a single computer. In another example, the communication management system 5 is configured as a plurality of computers to which one or more units (functions, means, or storages) are arbitrarily allocated. In other words, the communication management system 5 can be implemented by a plurality of servers that operate in cooperation with one another.

The PC 7 performs video communication using the image capturing device 8 connected thereto. In the embodiment, the PC 7 and the image capturing device 8 are provided in the same base C. In the base C, one user C is participating in video communication.

The smartphone 9 includes a display 917, which is described later, and displays an image of video communication on the display 917. The smartphone 9 includes a complementary metal oxide semiconductor (CMOS) sensor 905, and usually captures an image using the CMOS sensor 905. In addition, the smartphone 9 is configured to obtain data of two hemispherical images captured by the image capturing device 1b, from which a spherical panoramic image is to be generated, using wireless communication such as Wireless Fidelity (Wi-Fi) and Bluetooth (registered trademark). When wireless communication is used for obtaining the data of two hemispherical images, a cradle 2b supplies power with the image capturing device 1b and holds the image capturing device 1b, but not establish a communication. In the embodiment, the image capturing device 1b, the cradle 2b, and the smartphone 9 are provided in the same base B. Further, in the base B, two users B1 and B2 are participating in video communication.

Each of the videoconference terminal 3a, 3d, the PC 7 and the smartphone 9 is an example of a communication terminal. OpenGL ES is installed in each of the communication terminals to enable each of the communication terminals to generate predetermined-area information that indicates a partial area of a spherical panoramic image, or to generate a predetermined-area image from a spherical panoramic image that is transmitted from a different one of the communication terminals.

The arrangement of the terminals, apparatuses and users illustrated in FIG. 9 is just an example, and any other suitable arrangement will suffice. For example, an image capturing device configured to capture a spherical panoramic image can be used in place of the image capturing device 8 in the base C. In addition, examples of the communication terminal also include a digital television, a smartwatch, and a car navigation system. In the following description, any arbitrary one of the images capturing device 1a and the image capturing device 1b is referred to as “image capturing device 1”. Any arbitrary one of the videoconferences terminal 3a and the videoconference terminal 3b is referred to as “videoconference terminal 3”. Any arbitrary one of the displays 4a and the display 4b is referred to as “display 4”.

<<Hardware Configuration of Embodiment>>

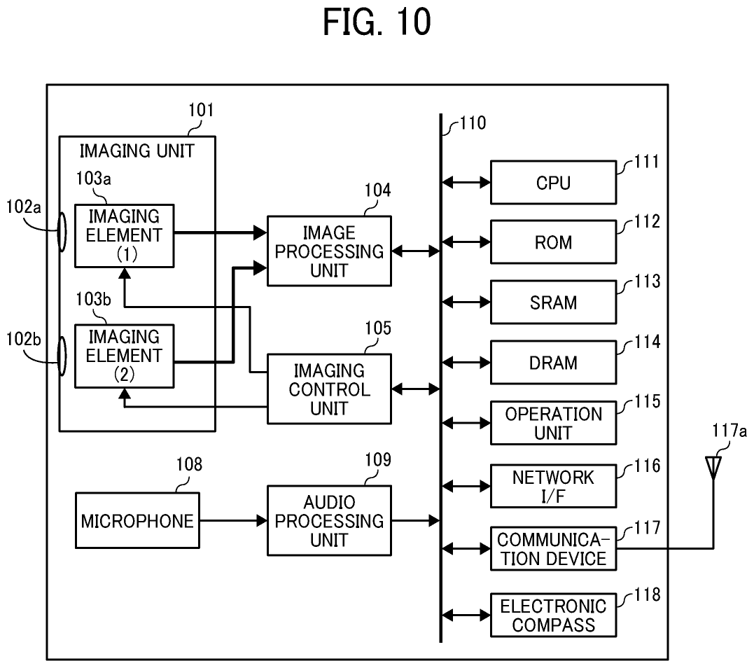

Hereinafter, a description is given of hardware configurations of the image capturing device 1, the videoconference terminal 3, the communication management system 5, the PC 7, and the smartphone 9, according to the present embodiment, with reference to FIG. 10 to FIG. 13. Since the image capturing device 8 is a general-purpose camera, a detailed description thereof is omitted.

<Hardware Configuration of Image Capturing Device 1>

First, referring to FIG. 10, a hardware configuration of the image capturing device 1 is described according to the embodiment. FIG. 10 is a block diagram illustrating a hardware configuration of the image capturing device 1 according to the embodiment. The following describes a case in which the image capturing device 1 is a spherical (omnidirectional) image capturing device having two imaging elements. However, the image capturing device 1 can include any suitable number of imaging elements, providing that it includes at least two imaging elements. In addition, the image capturing device 1 is not necessarily an image capturing device dedicated to omnidirectional image capturing. In another example, an external omnidirectional image capturing unit can be attached to a general-purpose digital camera or a smartphone to implement an image capturing device having substantially the same function as that of the image capturing device 1.

As illustrated in FIG. 10, the image capturing device 1 includes an imaging unit 101, an image processing unit 104, an imaging control unit 105, a microphone 108, an audio processing unit 109, a central processing unit (CPU) 111, a read only memory (ROM) 112, a static random access memory (SRAM) 113, a dynamic random access memory (DRAM) 114, the operation unit 115, a network interface (I/F) 116, a communication device 117, and an antenna 117a.

The imaging unit 101 includes two wide-angle lenses (so-called fisheye lenses) 102a and 102b, each having an angle of view of equal to or greater than 180 degrees to form a hemispherical image. The imaging unit 101 further includes the two imaging elements 103a and 103b corresponding to the wide-angle lenses 102a and 102b respectively. Each of the imaging elements 103a and 103b includes an imaging sensor such as a CMOS sensor and a charge-coupled device (CCD) sensor, a timing generation circuit, and a group of registers. The imaging sensor converts an optical image formed by the fisheye lenses 102a and 102b into electric signals to output image data. The timing generation circuit generates horizontal or vertical synchronization signals, pixel clocks and the like for the imaging sensor. Various commands, parameters and the like for operations of the imaging elements 103a and 103b are set in the group of registers.

Each of the imaging elements 103a and 103b of the imaging unit 101 is connected to the image processing unit 104 via a parallel I/F bus. In addition, each of the imaging elements 103a and 103b of the imaging unit 101 is connected to the imaging control unit 105 via a serial I/F bus such as an 12C bus. Each of the image processing unit 104 and the imaging control unit 105 is connected to the CPU 111 via a bus 110. Furthermore, the ROM 112, the SRAM 113, the DRAM 114, the operation unit 115, the network I/F 116, the communication device 117, and the electronic compass 118 are also connected to the bus 110.

The image processing unit 104 obtains image data from each of the imaging elements 103a and 103b via the parallel I/F bus and performs predetermined processing on the image data obtained from each of the imaging elements 103a and 103b separately. Thereafter, the image processing unit 104 combines these image data to generate data of the Mercator image as illustrated in FIG. 3C.

The imaging control unit 105 usually functions as a master device while each of the imaging elements 103a and 103b usually functions as a slave device. The imaging control unit 105 sets commands and the like in the group of registers of each of the imaging elements 103a and 103b via the I2C bus. The imaging control unit 105 receives necessary commands from the CPU 111. Further, the imaging control unit 105 obtains status data of the group of registers of each of the imaging elements 103a and 103b via the 12C bus. The imaging control unit 105 sends the obtained status data to the CPU 111.

The imaging control unit 105 instructs the imaging elements 103a and 103b to output the image data at a time when the shutter button of the operation unit 115 is pressed. The image capturing device 1 can support a preview display function (e.g., displaying a preview on a display such as a display of the videoconference terminal 3) or a movie display function. In case of displaying movie, image data are continuously output from the imaging elements 103a and 103b at a predetermined frame rate (frames per minute).

Furthermore, the imaging control unit 105 operates in cooperation with the CPU 111, to synchronize the time when the imaging element 103a outputs image data and the time when the imaging element 103b outputs the image data. In the present embodiment, the image capturing device 1 does not include a display unit (display). However, in another example, the image capturing device 1 can include a display.

The microphone 108 converts sound into audio data (signal). The audio processing unit 109 obtains audio data output from the microphone 108 via an I/F bus and performs predetermined processing on the audio data.

The CPU 111 controls entire operation of the image capturing device 1 and performs necessary processing. The ROM 112 stores various programs for execution by the CPU 111. Each of the SRAM 113 and the DRAM 114 operates as a work memory to store programs loaded from the ROM 112 for execution by the CPU 111 or data being currently processed. More specifically, in one example, the DRAM 114 stores image data currently processed by the image processing unit 104 and data of the Mercator image on which processing has been performed.

The operation unit 115 collectively refers to various operation keys, a power switch, the shutter button, and a touch panel having functions of both displaying information and receiving input from a user, which can be used in combination. A user operates the operation keys to input various image capturing (photographing) modes or image capturing (photographing) conditions.

The network I/F 116 collectively refers to an interface circuit such as a USB I/F that enables the image capturing device 1 to communicate data with an external medium such as a secure digital (SD) card or an external personal computer. The network I/F 116 supports at least one of wired and wireless communications. The data of the Mercator image, which is stored in the DRAM 114, can be stored in the external medium via the network I/F 116 or transmitted to extraneous sources such as the videoconference terminal 3 via the network I/F 116, as needed.

The communication device 117 communicates with extraneous sources such as the videoconference terminal 3 via the antenna 117a of the image capturing device 1 using a short-range wireless communication network such as Wi-Fi and Near Field Communication (NFC). The communication device 117 can also transmits the data of Mercator image to the extraneous sources such as the videoconference terminal 3.

The electronic compass 118 computes an orientation and a tilt (roll angle) of the image capturing device 1 based on the Earth's magnetism to output orientation and tilt information. This orientation and tilt information is an example of related information, which is metadata described in compliance with Exit. This information is used for image processing such as image correction on captured images. The related information also includes data indicating a time (date) when an image is captured by the image capturing device 1, and data indicating a size of image data, for example.

<Hardware Configuration of Videoconference Terminal 3>

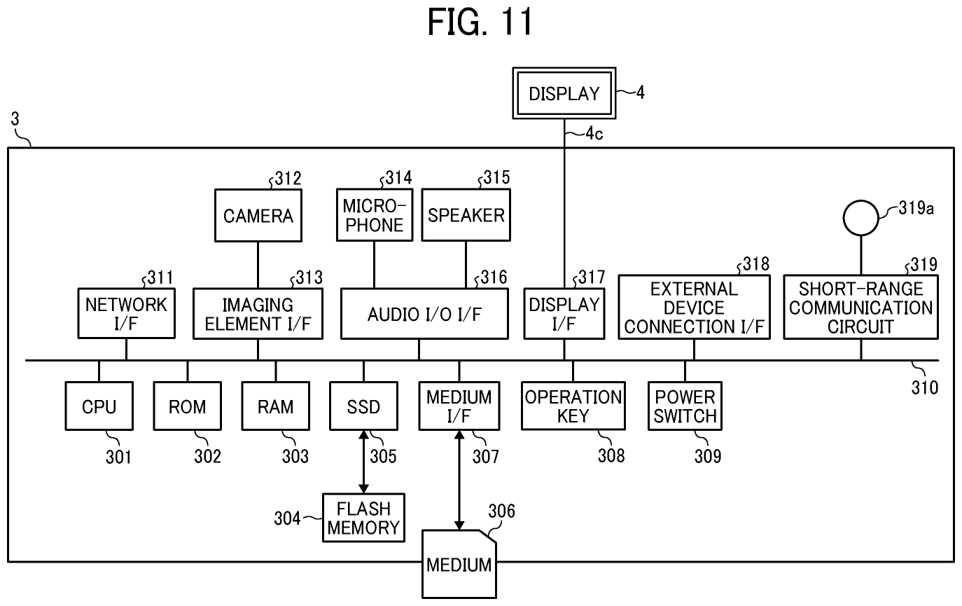

Next, referring to FIG. 11, a hardware configuration of the videoconference terminal 3 is described according to the embodiment. FIG. 11 is a block diagram illustrating a hardware configuration of the videoconference terminal 3 according to the embodiment. As illustrated in FIG. 11, the videoconference terminal 3 includes a CPU 301, a ROM 302, a RAM 303, a flash memory 304, a solid state drive (SSD) 305, a medium I/F 307, an operation key 308, a power switch 309, a bus line 310, a network I/F 311, a camera 312, an imaging element I/F 313, a microphone 314, a speaker 315, an audio input/output I/F 316, a display I/F 317, an external device connection I/F 318, a short-range communication circuit 319, and an antenna 319a for the short-range communication circuit 319.

The CPU 301 controls entire operation of the videoconference terminal 3. The ROM 302 stores a control program such as an Initial Program Loader (IPL) to boot the CPU 301. The RAM 303 is used as a work area for the CPU 301. The flash memory 304 stores various data such as a communication control program, image data, and audio data. The SSD 305 controls reading and writing of various data from and to the flash memory 304 under control of the CPU 301. In alternative to the SSD, a hard disc drive (HDD) can be used. The medium I/F 307 controls reading and writing (storing) of data from and to a storage medium 306 such as a flash memory. The operation key (keys) 308 is operated by a user to input a user instruction such as a user selection of a destination of communication from the videoconference terminal 3. The power switch 309 is a switch that turns on or off the power of the videoconference terminal 3.

The network I/F 311 in an interface that controls communication of data between the videoconference terminal 3 and extraneous sources through the communication network 100 such as the Internet. The camera 312 is an example of a built-in imaging device configured to capture a subject under control of the CPU 301 to obtain image data. The imaging element I/F 313 is a circuit that controls driving of the camera 312. The microphone 314 is an example of a built-in audio collecting device configured to input audio. The audio input/output I/F 316 is a circuit for controlling input and output of audio signals between the microphone 314 and the speaker 315 under control of the CPU 301. The display I/F 317 is a circuit for transmitting image data to the display 4, which is external to the videoconference terminal 3, under control of the CPU 301. The external device connection I/F 318 is an interface that connects the videoconference terminal 3 to various external devices. The short-range communication circuit 319 is a communication circuit in compliance with the NFC standard, Bluetooth (registered trademark) or the like.

The bus line 310 is an address bus, a data bus or the like, which electrically connects the elements illustrated in FIG. 11 such as the CPU 301.

The display 4 is an example of a display device that displays an image of a subject, an operation icon, etc. The display 4 is configured as a liquid crystal display or an organic electroluminescence (EL) display, for example. The display 4 is connected to the display I/F 317 by a cable 4c. For example, the cable 4c is an analog red green blue (RGB) (video graphic array (VGA)) signal cable, a component video cable, a high-definition multimedia interface (HDMI) (registered trademark) signal cable, or a digital video interactive (DVI) signal cable.

The camera 312 includes a lens and a solid-state imaging element that converts an image (video image) of subject to electronic data by photoelectric conversion. Examples of the solid-state imaging element include a CMOS sensor and a CCD sensor. The external device connection I/F 318 is configured to connect the videoconference terminal 3 to extraneous sources such as an external camera, an external microphone, or an external speaker through a USB cable or the like. When an external camera is connected, the external camera is driven in preference to the built-in camera 312 under control of the CPU 301. Similarly, when an external microphone is connected, or an external speaker is connected, the external microphone or the external speaker is driven in preference to the built-in microphone 314 or the built-in speaker 315 under control of the CPU 301.

The storage medium 306 is removable from the videoconference terminal 3. In addition to or in alternative to the flash memory 304, any suitable nonvolatile memory, such as an electrically erasable and programmable ROM (EEPROM) can be used, if it reads or writes data under control of CPU 301.

<Hardware Configuration of Communication Management System 5 and PC 7>

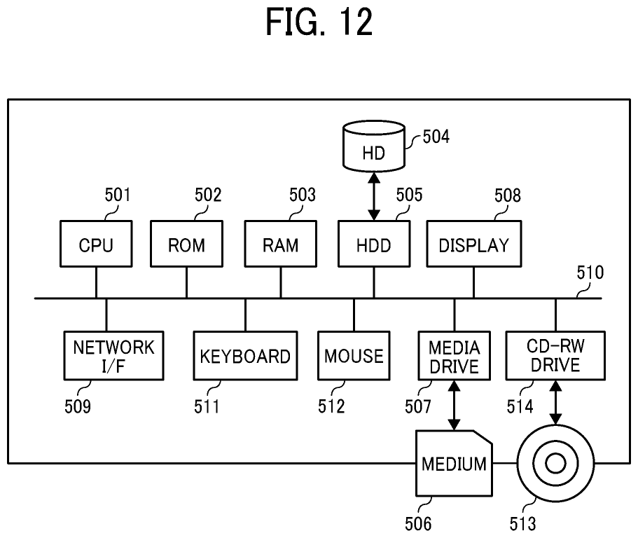

Next, referring to FIG. 12, a hardware configuration of each of the communication management system 5 and the PC 7 is described, according to the embodiment. FIG. 12 is a block diagram illustrating an example of the hardware configuration of any one of the communication management system 5 and the PC 7. In the embodiment, the communication management system 5 and the PC 7 are individually implemented by a computer. Therefore, a description is given of a configuration of the communication management system 5, and the description of a configuration of the PC 7 is omitted, having the same or substantially the same configuration as that of the communication management system 5.

The communication management system 5 includes a CPU 501, a ROM 502, a RAM 503, a hard disc (HD) 504, an HDD 505, a media drive 507, a display 508, a network I/F 509, a keyboard 511, a mouse 512, a compact disc rewritable (CD-RW) drive 514, and a bus line 510. The CPU 501 controls entire operation of the communication management system 5. The ROM 502 stores a control program such as an IPL to boot the CPU 501. The RAM 503 is used as a work area for the CPU 501. The HD 504 stores various types of data, such as a control program for the communication management system 5. The HDD 505 controls reading and writing of various data from and to the HD 504 under control of the CPU 501. The media drive 507 controls reading and writing (storing) of data from and to a storage medium 506 such as a flash memory. The display 508 displays various information such as a cursor, menu, window, characters, or image. The network I/F 509 is an interface that controls communication of data between the communication management system 5 and extraneous sources through the communication network 100. The keyboard 511 includes a plurality of keys to allow a user to input characters, numerals, or various instructions. The mouse 512 allows a user to select a specific instruction or execution, select a target for processing, or move a cursor being displayed. The CD-RW drive 514 controls reading and writing of various data from and to a CD-RW 513, which is one example of a removable storage medium. The bus line 510 is an address bus, a data bus or the like, which electrically connects the above-described hardware elements, as illustrated in FIG. 12.

<Hardware Configuration of Smartphone 9>

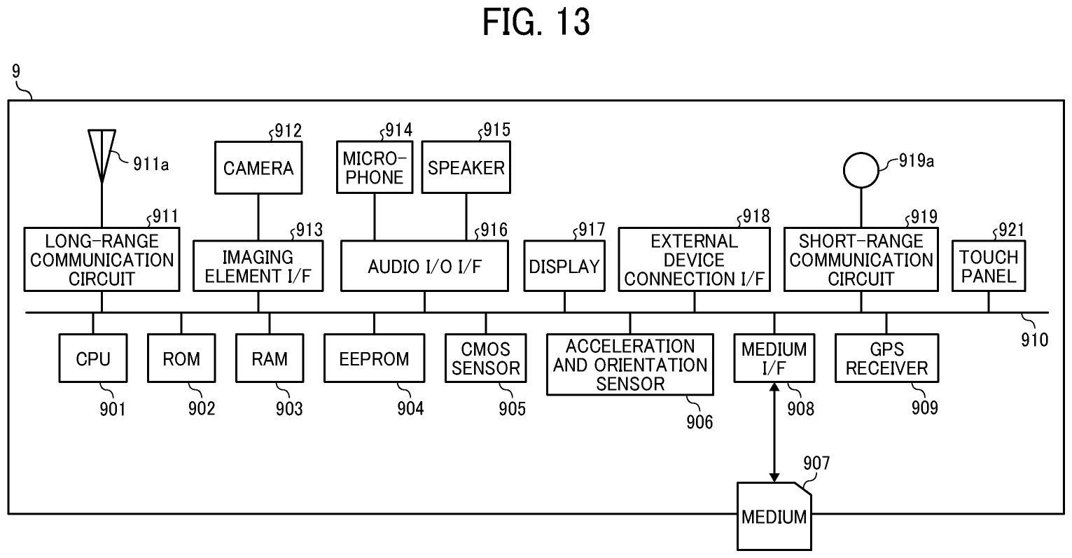

Referring to FIG. 13, a hardware configuration of the smartphone 9 is described, according to the embodiment. FIG. 13 is a block diagram illustrating a hardware configuration of the smartphone 9, according to the embodiment. As illustrated in FIG. 13, the smartphone 9 includes a CPU 901, a ROM 902, a RAM 903, an EEPROM 904, a CMOS sensor 905, an acceleration and orientation sensor 906, a medium I/F 908, and a global positioning system (GPS) receiver 909.

The CPU 901 controls entire operation of the smartphone 9. The ROM 902 stores a control program such as an IPL to boot the CPU 901. The RAM 903 is used as a work area for the CPU 901. The EEPROM 904 reads or writes various data such as a control program for a smartphone under control of the CPU 901. The CMOS sensor 905 captures an object (mainly, a self-image of a user operating the smartphone 9) under control of the CPU 901 to obtain image data. The acceleration and orientation sensor 906 include various sensors such as an electromagnetic compass for detecting geomagnetism, a gyrocompass, and an acceleration sensor. The medium I/F 908 controls reading and writing of data from and to a storage medium 907 such as a flash memory. The GPS receiver 909 receives GPS signals from a GPS satellite.

The smartphone 9 further includes a long-range communication circuit 911, a camera 912, an imaging element I/F 913, a microphone 914, a speaker 915, an audio input/output I/F 916, a display 917, an external device connection I/F 918, a short-range communication circuit 919, an antenna 919a for the short-range communication circuit 919, and a touch panel 921.

The long-range communication circuit 911 is a circuit that enables the smartphone 9 to communicate with other device through the communication network 100. The camera 912 is an example of a built-in imaging device configured to capture a subject under control of the CPU 901 to obtain image data. The imaging element I/F 913 is a circuit that controls driving of the camera 912. The microphone 914 is an example of a built-in audio collecting device configured to input audio. The audio input/output I/F 916 is a circuit for controlling input and output of audio signals between the microphone 914 and the speaker 915 under control of the CPU 901. The display 917 is an example of a display device that displays an image of a subject, various icons, etc. The display 917 is configured as a liquid crystal display or an organic EL display, for example. The external device connection I/F 918 is an interface that connects the smartphone 9 to various external devices. The short-range communication circuit 919 is a communication circuit in compliance with the NFC standard, Bluetooth (registered trademark) or the like. The touch panel 921 is an example of an input device that enables a user to operate the smartphone 9 by touching a screen of the display 917.

The smartphone 9 further includes a bus line 910. The bus line 910 is an address bus, a data bus or the like, which electrically connects the elements in FIG. 13 such as the CPU 901.

In addition, a storage medium such as a CD-ROM storing any of the above-described programs and/or an HD storing any of the above-described programs can be distributed domestically or overseas as a program product.

<<Functional Configuration of Embodiment>>

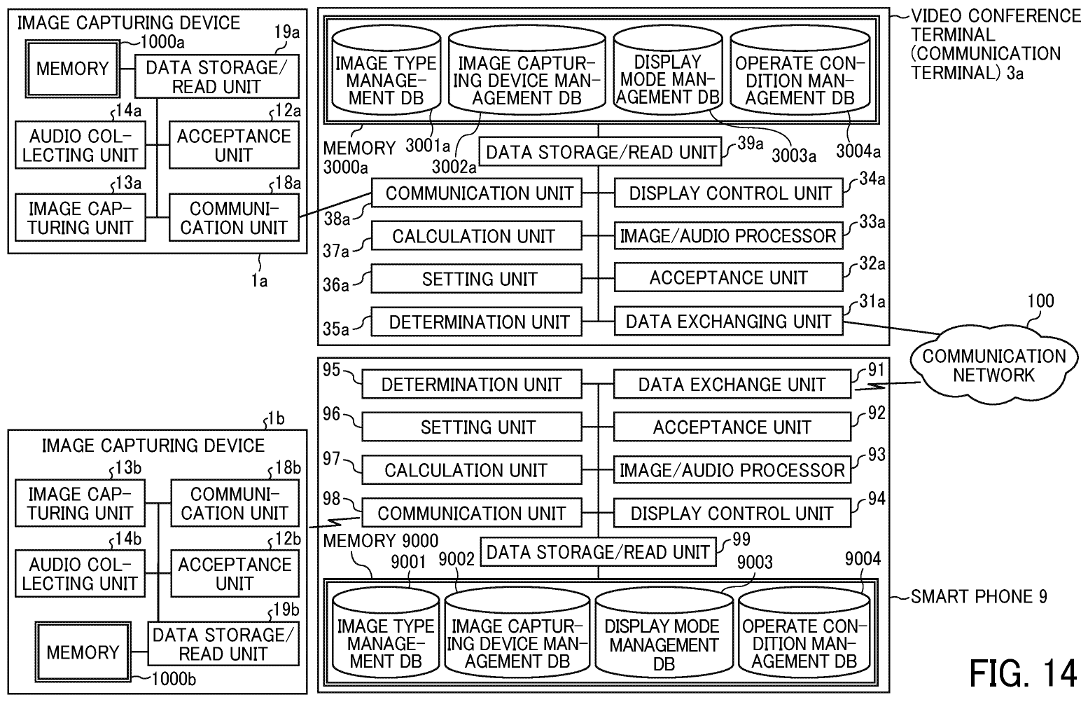

Referring to FIGS. 14 to 21, a functional configuration of the image communication system is described according to the present embodiment. FIGS. 14A and 14B are a schematic functional block diagram illustrating functional configurations of the image capturing device 1a, the image capturing device 1b, the videoconference terminal 3, the communication management system 5, the PC 7 and the smartphone 9, which constitute a part of the image communication system, according to the embodiment.

<Functional Configuration of Image Capturing Device 1a>

As illustrated in FIG. 14B, the image capturing device 1a includes, for example, an acceptance unit 12a, an image capturing unit 13a, an audio collecting unit 14a, a communication unit 18a, and a data storage/read unit 19a. Each of the above-mentioned units is a function or means that is implemented by or that is caused to function by operating any one or more of the hardware elements illustrated in FIG. 10 in cooperation with instructions from the CPU 111 according to a control program for the image capturing device 1a, expanded from the SRAM 113 to the DRAM 114.

The image capturing device 1a further includes a memory 1000a, which is implemented by the ROM 112, the SRAM 113, and the DRAM 114 illustrated in FIG. 10. The memory 1000a stores therein a globally unique identifier (GUID) identifying the own device (i.e., the image capturing device 1a itself).

The image capturing device 1b includes an acceptance unit 12b, an image capturing unit 13b, an audio collecting unit 14b, a communication unit 18b, and a data storage/read unit 19b. These functional units of the image capturing device 1b implement the similar or substantially the similar functions as those of the acceptance unit 12a, the image capturing unit 13a, the audio collecting unit 14a, the communication unit 18a, and the data storage/read unit 19a of the image capturing device 1a, respectively. Therefore, redundant descriptions thereof are omitted below.

Each Functional Unit of Image Capturing Device 1a:

Referring to FIG. 10 and FIG. 14B, each of the functional units of the image capturing device 1a is described in detail.

The acceptance unit 12a of the image capturing device 1a is mainly implemented by the operation unit 115 illustrated in FIG. 10, which operates under control of the CPU 111. The acceptance unit 12a receives an instruction input from the operation unit 115 according to a user operation.

The image capturing unit 13a is implemented mainly by the imaging unit 101, the image processing unit 104, and the imaging control unit 105, illustrated in FIG. 10, each of which operates under control of the CPU 111. The image capturing unit 13 captures an image of object or surroundings to obtain captured-image data.

The audio collecting unit 14a is mainly implemented by the microphone 108 and the audio processing unit 109 illustrated in FIG. 10, each of which operates under control of the CPU 111. The audio collecting unit 14a collects sounds around the image capturing device 1a.

The communication unit 18a, which is mainly implemented by instructions of the CPU 111, communicates data with a communication unit 38 of the videoconference terminal 3 using a short-range wireless communication network in compliance with the NFC standard, Bluetooth (registered trademark), or Wi-Fi, for example.

The data storage/read unit 19a, which is mainly implemented by instructions of the CPU 111 illustrated in FIG. 10, stores various data or information in the memory 1000a and reads out various data or information from the memory 1000a.

<Functional Configuration of Videoconference Terminal 3a>

As illustrated in FIG. 14B, the videoconference terminal 3a includes a data exchange unit 31a, an acceptance unit 32a, an image/audio processor 33a, a display control unit 34a, a determination unit 35a, a setting unit 36a, a communication unit 38a, and a data storage/read unit 39a. Each of the above-mentioned units is a function or means that is implemented by or that is caused to function by operating any one or more of the hardware elements illustrated in FIG. 11 in cooperation with instructions from the CPU 301 according to a control program for the videoconference terminal 3, expanded from the flash memory 304 to the RAM 303. [0071].

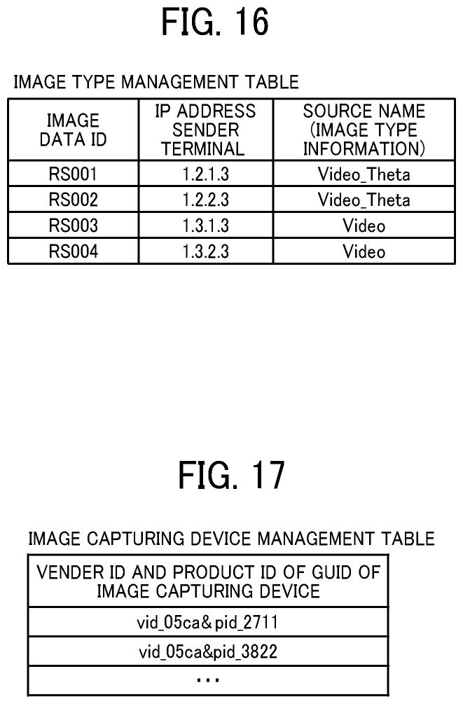

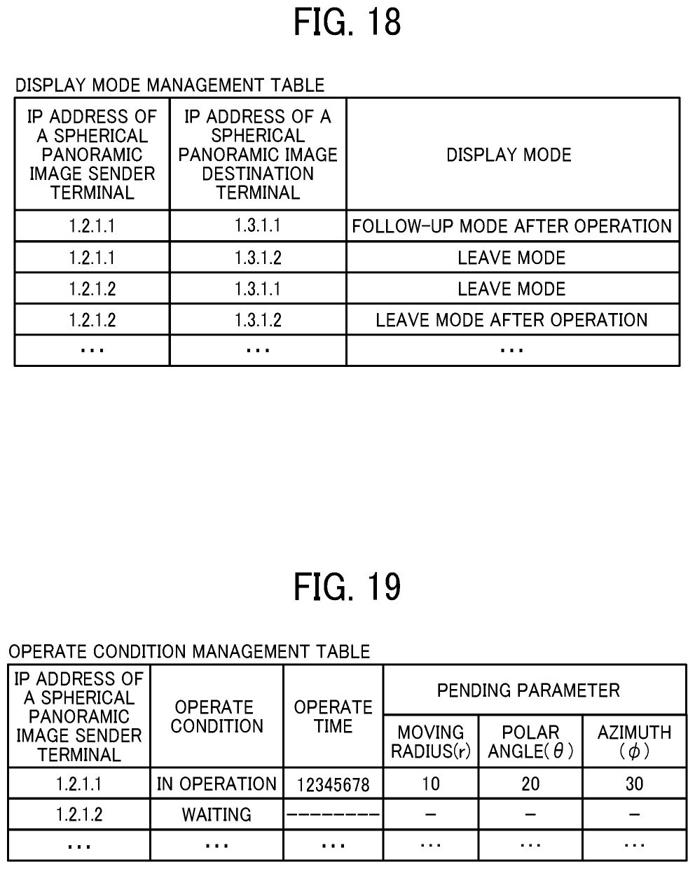

The videoconference terminal 3a further includes a memory 3000a, which is implemented by the ROM 302, the RAM 303, and the flash memory 304 illustrated in FIG. 11. The memory 3000a includes an image type management database (DB) 3001a, an image capturing device management DB 3002a, a display mode management DB 3003a, and an operate condition management DB 3004a. Among these DBs, the image type management DB 3001a is configured as an image type management table as illustrated in FIG. 16. The image capturing device management DB 3002a is configured as an image capturing device management table as illustrated in FIG. 17. The display mode management DB 3003a is configured as an display mode management table as illustrated in FIG. 18. an operate condition management DB 3004a is configured as an operate condition management table as illustrated in FIG. 19.

The videoconference terminal 3d includes a data exchange unit 31d, an acceptance unit 32d, an image/audio processor 33d, a display control unit 34d, a determination unit 35d, a generator 36d, a communication unit 38d, a data storage/read unit 39d and a memory 3000d. These functional units of the videoconference terminal 3d implement the similar or substantially the similar functions as those of a data exchange unit 31a, an acceptance unit 32a, an image/audio processor 33a, a display control unit 34a, a determination unit 35a, a generator 36a, a communication unit 38a, a data storage/read unit 39a and a memory 3000a of videoconference terminal 3a, respectively. Therefore, redundant descriptions thereof are omitted below. The memory 3000d of the videoconference terminal 3d includes an image type management database (DB) 3001a, an image capturing device management DB 3002a, a display mode management DB 3003a, and an operate condition management DB 3004a. The memory 3000d of the videoconference terminal 3d implement the similar or substantially the similar functions as those of an image type management database (DB) 3001a, an image capturing device management DB 3002a, a display mode management DB 3003a, and an operate condition management DB 3004a of videoconference terminal 3a, respectively. Therefore, redundant descriptions thereof are omitted below.

Image Type Management Table:

FIG. 16 is an illustration of an example data structure of the image type management table. The image type management table stores an image data identifier (ID), an internet protocol (IP) address, which is an example of an address of a terminal as a transmission source of image data, and a source name, in association with one another. The terminal as a transmission source is hereinafter referred to as a “sender terminal”. The image data ID is one example of image data identification information identifying image data to be used in video communication. The same image data ID is assigned to image data transmitted from the same sender terminal. By using the image data ID, a destination terminal (that is, a communication terminal that receives image data) identifies a sender terminal from which the received image data is transmitted. An IP address of the sender terminal, which is associated with a specific image data ID, is an IP address of a communication terminal that transmits image data identified by that image data ID associated with the IP address. A source name, which is associated with a specific image data ID, is a name for specifying an image capturing device that outputs the image data identified by that image data ID associated with the source name. The source name is one example of image type information. The source name is a name generated by a communication terminal such as the videoconference terminal 3a according to a predetermined naming rule.

The IP address of the communication terminal is an example of terminal identification information (the same applies hereinafter). For example, IP addresses are respectively “1.2.1.3”, “1.2.2.3”, “1.3.1.3”, and “1.3.2.3” transmit image data identified by the image data ID “RS001”, “RS002”, “RS003” and “RS004”, respectively. Further, according to the image type management table illustrated in FIG. 16, the image types represented by the source names of those four communication terminals are “Video_Theta”, “Video_Theta”, “Video”, and “Video”, that indicate the image types, which are “special image”, “special image”, “general image”, and “general image”, respectively. In the embodiment, the “special image” is a spherical panoramic image.

In another example, data other than the image data are stored in the image type management table in association with the image data ID. Examples of the data other than the image data include audio data and presentation material data to be shared on a screen.

Image Capturing Device Management Table:

FIG. 17 is an illustration of an example data structure of the image capturing device management table. The image capturing device management table stores a vendor ID and a product ID among the GUIDs of an image capturing device that is configured to obtain two hemispherical images, from which a spherical panoramic image is generated. As the GUID, a combination of a vendor ID (VID) and a product ID (PID) used in a USB device is used, for example. The vendor ID and the product ID are stored in a communication terminal such as a videoconference terminal before shipment. In another example, these IDs are added and stored in the communication terminal after shipment.

Display Mode Management Table:

FIG. 18 is an illustration of an example data structure of the display mode management table. The display mode management table stores an internet protocol (IP) address as an identification information of a spherical panoramic image sender terminal, an internet protocol (IP) address as an identification information of a spherical panoramic image destination terminal, and a plural kind of display mode. The information managed by the display mode management table can be set by the communication terminal at each base. The set information is transmitted to the communication terminals of all other bases via the communication management system 5, and the communication information of each base can share the same information.

Here, each type of display mode will be described. The display mode includes a follow-up mode after operation, a leave mode after operation, and a leave mode. In the follow-up mode after operation and the leave mode after operation, when the destination terminal receives the predetermined area information from the sender terminal and the operation state for the display image on the destination terminal is not operating (changing) the predetermined area image in the spherical panoramic image, the destination terminal preferentially displays the predetermined area image indicated by the predetermined area information.

Further, in the follow-up mode after operation, the destination terminal gives priority to continuation of the operation without following the predetermined area information, and then displays the predetermined area image indicated by the predetermined area information after the operation is completed.

On the other hand, in the leave mode after operation, the destination terminal gives priority to continuation of the operation without following the predetermined area information, and does not display the predetermined area image indicated by the predetermined area information even after the operation is finished. The predetermined area image at the end of operation is kept displayed.

Further, in the leave mode, when the destination terminal receives the predetermined area information from the sender terminal, whether the operation state for the display image at the destination terminal is operating the predetermined area image in the spherical panoramic image or not, the destination terminal does not follow the predetermined area information and keeps displaying the predetermined area image displayed at the present time.

Note that the types of display modes are not limited to three as described above, but may be two types or four or more types.

In addition, the “leave mode” may not be set, and nothing may be set, so that the “leave mode” may be handled.

Operation Status Management Table:

FIG. 19 is a conceptual diagram showing an operate condition management table. In the operation condition management table, for each of the IP address of the spherical panoramic image sender terminal, the operate condition of the communication terminal with respect to the image data, the operate time, and the pending parameter are associated and managed. Thereby, the operation status by the communication terminal in which the operate condition management table for the image data is stored can be managed.

The IP address of the spherical panoramic image sender terminal is an example of terminal identification information of the communication terminal that is sending the spherical panoramic image (captured image data).

The operation state indicates that the user is operating on a predetermined area image, which is a partial area in the spherical panoramic image (captured image data) sent from the sender terminal, or is waiting without being operated. The operation for the predetermined area image is an operation for changing the predetermined area image displayed on the display in one spherical panoramic image. This operation is performed when the user moves the cursor displayed on the display with a mouse or the like, or when the user swipes on the display with a finger. “In operation” indicates a state in which an operation is being performed on a predetermined area image displayed on the display. “Waiting” indicates a state in which a predetermined time (for example, 3 seconds) or more has elapsed since the last operation on the predetermined area image displayed on the display. “Waiting” may be played as “not in operation”.

The operation time indicates the time when the user last operated the predetermined area image when the operation state is “in operation”, and is recorded in a time stamp state, for example.

The pending parameter indicates predetermined area information received when the operation state is “in operation” at the destination terminal. The pending parameter is used to display a predetermined area image after the operation state is changed from “In operation” to “Waiting”. When there is no such a pending parameter, “none” is set or nothing is set.

Each Functional Unit of Videoconference Terminal 3a:

Referring to FIG. 11 and FIG. 14B, each of the functional units of the videoconference terminal 3a is described in detail.

The data exchange unit 31a of the videoconference terminal 3a is mainly implemented by the network I/F 311 illustrated in FIG. 11, which operates under control of the CPU 301. The data exchange unit 31a exchanges various data or information with communication management system 5 via the communication network 100.

The acceptance unit 32a is mainly implemented by the operation key 308, which operates under control of the CPU 301. The acceptance unit 32a receives selections or inputs according to a user operation. In another example, an input device such as a touch panel is used in addition to or in place of the operation key 308.

The image/audio processor 33a, which is implemented by instructions of the CPU 301 illustrated in FIG. 11, processes image data obtained by capturing a subject by the camera 312. After voice sound generated by a user is converted to audio signals by the microphone 314, the image/audio processor 33a performs processing on audio data corresponding to the audio signals.

Further, the image/audio processor 33a processes image data received from another communication terminal based on the image type information such as the source name. The display control unit 34a causes the display 4 to display an image based on the processed image data. More specifically, when the image type information indicates “special image”, the image/audio processor 33a converts the image data such as hemispherical image data as illustrated in FIG. 3A and FIG. 3B into spherical panoramic image data to generate a spherical panoramic image as illustrated in FIG. 4B. Further, the image/audio processor 33 generates a predetermined-area image as illustrated in FIG. 6B. Furthermore, the image/audio processor 33a outputs, to the speaker 315, audio signals according to audio data received from another communication terminal via the communication management system 5. The speaker 315 outputs sound based on the audio signal.

The display control unit 34a is mainly implemented by the display I/F 317, which operates under control of the CPU 301. The display control unit 34 causes the display 4 to display various images or characters.

The determination unit 35a, which is mainly implemented by instructions of the CPU 301, determines an image type corresponding to image data received from, for example, the image capturing device 1a.

The setting unit 36a is mainly implemented by the processing of the CPU 301, and performs necessary settings based on various determination results by the determination unit 35a. For example, based on the result of being determined as a general image or a special image (here, a spherical panoramic image), a source name, which is an example of image type information, is set according to the above-described naming rule. If the determination unit 35a determines that the image is a general image, the setting unit 36a creates a source name “Video” indicating that the image is a general image. On the other hand, when the determination unit 35a determines that the image is a special image, the setting unit 36a sets a source name “Video_Theta” indicating that the image is a special image.

The calculation unit 37a is mainly implemented by the processing of the CPU 301, and calculates the direction of the predetermined area T1 with respect to the predetermined area T2 based on predetermined area information (i2) indicating the predetermined area T2, and the predetermined area information (i1) received from the other communication terminal by the data exchange 31a. The predetermined area information (i1) indicates a predetermined area T1 in the image data. In addition, when the whole image data is displayed, the displayed image data is also referred to “whole image”.

The communication unit 38a is mainly implemented by the short-range communication circuit 319 and the antenna 319a, each of which operates under control of the CPU 301. The communication unit 38 communicates with the communication unit 18a of the image capturing device 1a using the short-range wireless communication network in compliance with the NFC standard, Bluetooth (registered trademark), or Wi-Fi, for example. In the above description, the communication unit 38 and the data exchange unit 31 individually have a communication unit. In another example, the communication unit 38a and the data exchange unit 31a share a single communication unit.

The data storage/read unit 39a, which is mainly implemented by instructions of the CPU 301 illustrated in FIG. 11, stores various data or information in the memory 3000 and reads out various data or information from the memory 3000.

<Functional Configuration of Communication Management System 5>

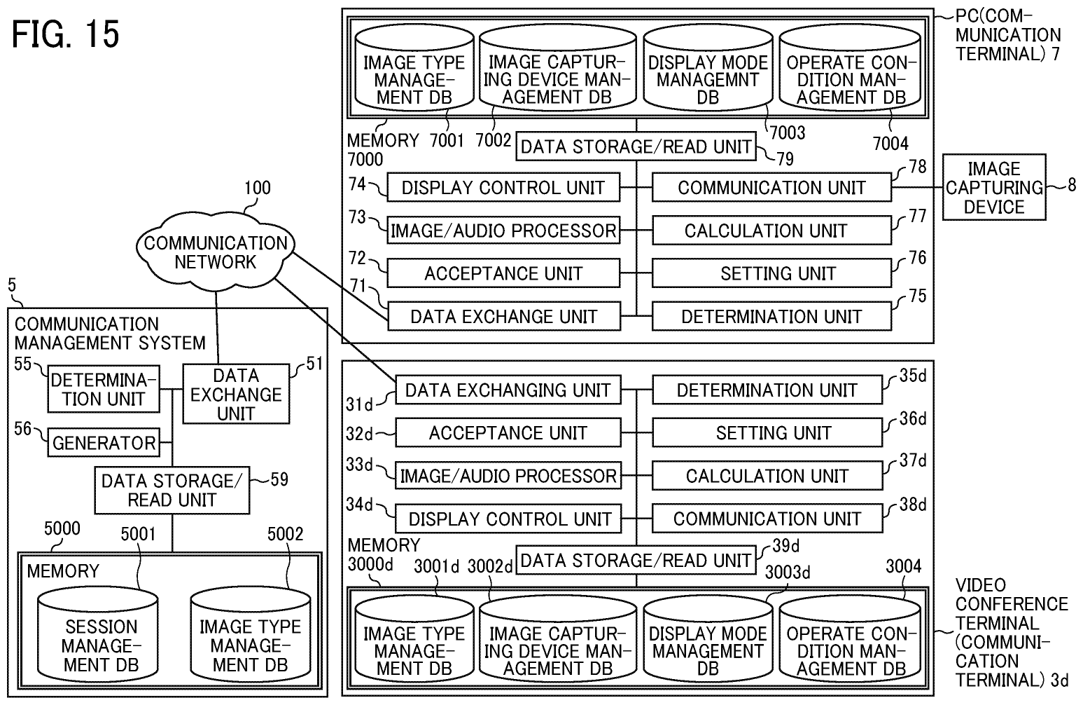

Referring to FIG. 12 and FIG. 15, each of the functional units of the communication management system 5 is described in detail. The communication management system 5 includes a data exchange unit 51, a determination unit 55, a generator 56, and a data storage/read unit 59. Each of the above-mentioned units is a function or means that is implemented by or that is caused to function by operating any one or more of the hardware elements illustrated in FIG. 12 in cooperation with instructions from the CPU 501 according to a control program for the communication management system 5, expanded from the HD 504 to the RAM 503.

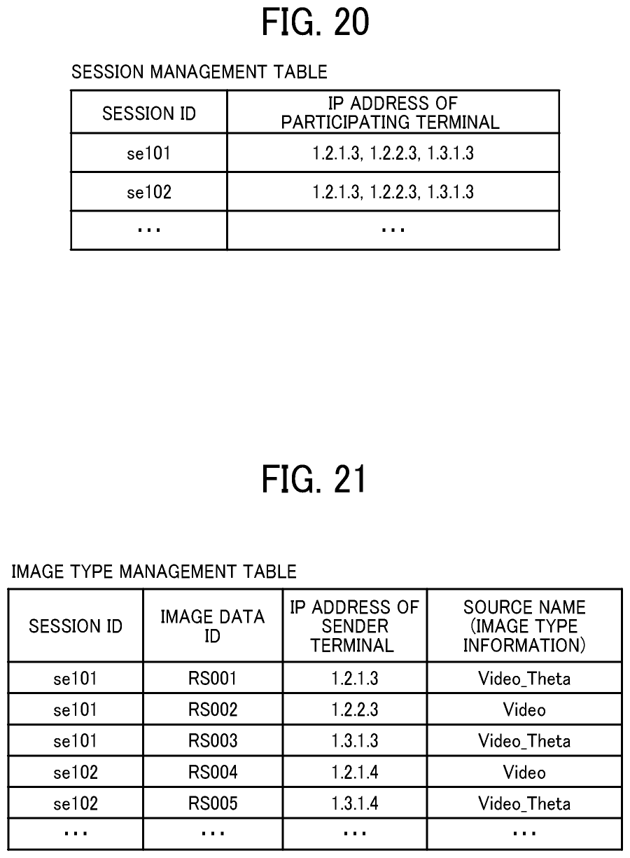

The communication management system 5 further includes a memory 5000, which is implemented by the RAM 503 and the HD 504 illustrated in FIG. 12. The memory 5000 includes a session management DB 5001, and an image type management DB 5002. The session management DB 5001 is configured as a session management table as illustrated in FIG. 20. The image type management DB 5002 is configured as an image type management table as illustrated in FIG. 21.

Session Management Table:

FIG. 20 is an illustration of an example data structure of the session management table. The session management table stores a session ID and an IP address of a participant communication terminal, in association with each other. The session ID is one example of session identification information for identifying a session that implements video communication. Each session ID is generated for a corresponding virtual conference room. The one or more session IDs are also stored and managed in each communication terminal, such as the videoconference terminal 3a, to be used by each communication terminal to select a communication session. The IP address of the participant communication terminal indicates an IP address of each of the communication terminal(s) participating in a virtual conference room identified by an associated session ID.

Image Type Management Table:

FIG. 21 is an illustration of an example data structure of the image type management table. The image type management table illustrated in FIG. 21 stores, in addition to the information items stored in the image type management table illustrated in FIG. 16, the same session IDs as those stored in the session management table, in association with one another. The example of the image type management table illustrated in FIG. 19 indicates that three communication terminals whose IP addresses are “1.2.1.3”, “1.2.2.3”, and “1.3.1.3” are participating in the virtual conference room identified by the session ID “se101”. The communication management system 5 stores the same image data ID, IP address of the sender terminal, and image type information as those stored in a communication terminal, such as the videoconference terminal 3a. This enables the communication management system 5 to transmit the image type information, etc., to a communication terminal that is currently participating in video communication and another communication terminal that newly participates in the video communication by entering a virtual conference room of the video communication. Accordingly, the communication terminal that is already in the video communication and the communication terminal that is newly participates in the video communication do not have to such information including the image type information.

Each Functional Unit of Communication Management System 5:

Referring to FIG. 12 and FIG. 15, each of the functional units of the communication management system 5 is described in detail.

The data exchange unit 51 of the communication management system 5 is mainly implemented by the network I/F 509, which operates under control of the CPU 501 illustrated in FIG. 12. The data exchange unit 51 exchanges various data or information with the videoconference terminal 3 or the PC 7 through the communication network 100.

The determination unit 55, which is mainly implemented by operation of the CPU 501, performs various determinations.

The generator 56, which is mainly implemented by instructions of the CPU 501, generate an image data ID.

The data storage/read unit 59 is mainly implemented by the HDD 505 illustrated in FIG. 12, which operates under control of the CPU 501. The data storage/read unit 59 stores various data or information in the memory 5000 and reads out various data or information from the memory 5000.

<Functional Configuration of PC 7>

Referring to FIG. 12 and FIG. 14, a functional configuration of the PC 7 is described according to the embodiment. The PC 7 has substantially the same functions as those of the videoconference terminal 3a. In other words, as illustrated in FIG. 14B, the PC 7 includes a data exchange unit 71, an acceptance unit 72, an image/audio processor 73, a display control unit 74, a determination unit 75, a generator 76, a communication unit 78, and a data storage/read unit 79. Each of the above-mentioned units is a function or means that is implemented by or that is caused to function by operating any one or more of the hardware elements illustrated in FIG. 12 in cooperation with instructions from the CPU 501 according to a control program for the PC 7, expanded from the HD 504 to the RAM 503.

The PC 7 further includes a memory 7000, which is implemented by the ROM 502, the RAM 503 and the HD 504 illustrated in FIG. 12. The memory 7000 includes an image type management DB 7001, an image capturing device management DB 7002, a display mode management DB 7003, and a operate condition management DB 7004. The image type management DB 7001, the image capturing device management DB 7002, a display mode management DB 7003, and a operate condition management DB 7004 have substantially the same data structure as the image type management DB 3001, the image capturing device management DB 3002, a display mode management DB 3003, and a operate condition management DB 3004, respectively, and redundant descriptions thereof are omitted below.

Each Functional Unit of PC 7:

The data exchange unit 71 of the PC 7 is mainly implemented by the network I/F 509, which operates under control of the CPU 501 illustrated in FIG. 12. The data exchange unit 71 implements the similar or substantially the similar function to that of the data exchange unit 31a.

The acceptance unit 72 is mainly implemented by the keyboard 511 and the mouse 512, which operates under control of the CPU 501. The acceptance unit 72 implements the similar or substantially the similar function to that of the acceptance unit 32a. The image/audio processor 73, which is mainly implemented by instructions of the CPU 501, implements the similar or substantially the similar function to that of the image/audio processor 33a. The display control unit 74, which is mainly implemented by instructions of the CPU 501, implements the similar or substantially the similar function to that of the display control unit 34a. The determination unit 75, which is mainly implemented by instructions of the CPU 501, implements the similar or substantially the similar function to that of the determination unit 35a. The generator 76, which is mainly implemented by instructions of the CPU 501, implements the similar or substantially the similar function to that of the generator 36a. The calculation unit 77, which is mainly implemented by instructions of the CPU 501, implements the similar or substantially the similar function to that of the calculation unit 37a. The communication unit 78, which is mainly implemented by instructions of the CPU 501, implements the similar or substantially the similar function to that of the communication unit 38a. The data storage/read unit 79a, which is mainly implemented by instructions of the CPU 501, stores various data or information in the memory 7000 and reads out various data or information from the memory 7000.

<Functional Configuration of Smartphone 9>

Referring to FIG. 13 and FIG. 14, a functional configuration of the smartphone 9 is described, according to the embodiment. The smartphone 9 has substantially the same functions as the videoconference terminal 3a. In other words, as illustrated in FIG. 14A, the smartphone 9 includes a data exchange unit 91, an acceptance unit 92, an image/audio processor 93, a display control unit 94, a determination unit 95, a setting unit 96, a communication unit 98, and a data storage/read unit 99. Each of the above-mentioned units is a function or means that is implemented by or that is caused to function by operating any one or more of the hardware elements illustrated in FIG. 13 in cooperation with instructions from the CPU 901 according to a control program for the smartphone 9, expanded from the EEPROM 904 to the RAM 903.

The smartphone 9 further includes a memory 9000, which is implemented by the ROM 902, the RAM 903, and the EEPROM 904 illustrated in FIG. 13. The memory 9000 includes an image type management DB 9001, an image capturing device management DB 9002, a display mode management DB 9003, and a operate condition management DB 9004. The image type management DB 9001, the image capturing device management DB 9002, a display mode management DB 9003, and a operate condition management DB 9004 have substantially the same data structure as the image type management DB 3001, the image capturing device management DB 3002, a display mode management DB 3003, and a operate condition management DB 3004, respectively, and the redundant descriptions thereof are omitted below.

Each Functional Unit of Smartphone 9:

The data exchange unit 91 of the smartphone 9 is mainly implemented by the long-range communication circuit 911 illustrated in the FIG. 13, which operates under control of the CPU 901. The data exchange unit 91 implements the similar or substantially the similar function to that of the data exchange unit 31a.

The acceptance unit 92 is mainly implemented by the touch panel 921, which operates under control of the CPU 901. The acceptance unit 92 implements the similar or substantially the similar function to that of the acceptance unit 32a.

The image/audio processor 93, which is mainly implemented by instructions of the CPU 901, implements the similar or substantially the similar function to that of the image/audio processor 33a. The display control unit 94, which is mainly implemented by instructions of the CPU 901, implements the similar or substantially the similar function to that of the display control unit 34a. The determination unit 95, which is mainly implemented by instructions of the CPU 901, implements the similar or substantially the similar function to that of the determination unit 35a. The setting unit 96, which is mainly implemented by instructions of the CPU 901, implements the similar or substantially the similar function to that of the setting unit 36a. The calculation unit 97, which is mainly implemented by instructions of the CPU 901, implements the similar or substantially the similar function to that of the calculation unit 37a. The communication unit 98, which is mainly implemented by instructions of the CPU 901, implements the similar or substantially the similar function to that of the communication unit 38a. The data storage/read unit 99, which is implemented by instructions of the CPU 901, stores various data or information in the memory 9000 and reads out various data or information from the memory 9000.

### Operation or Processes of Embodiment

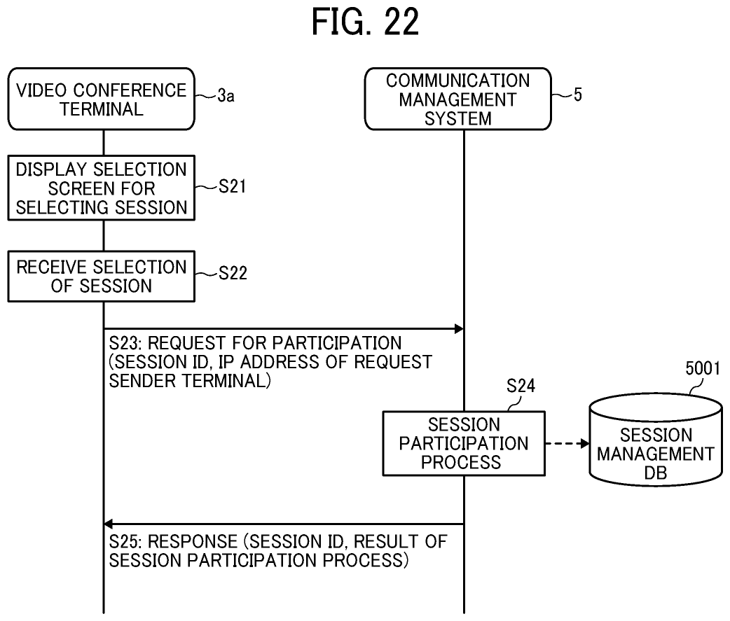

Referring to FIG. 22 to FIG. 31, a description is given of an operation or processes according to the present embodiment.

<Participation Process>

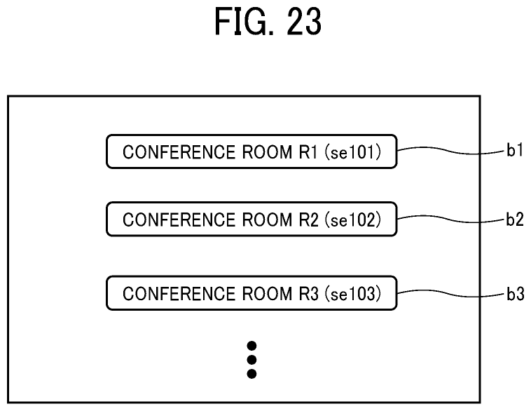

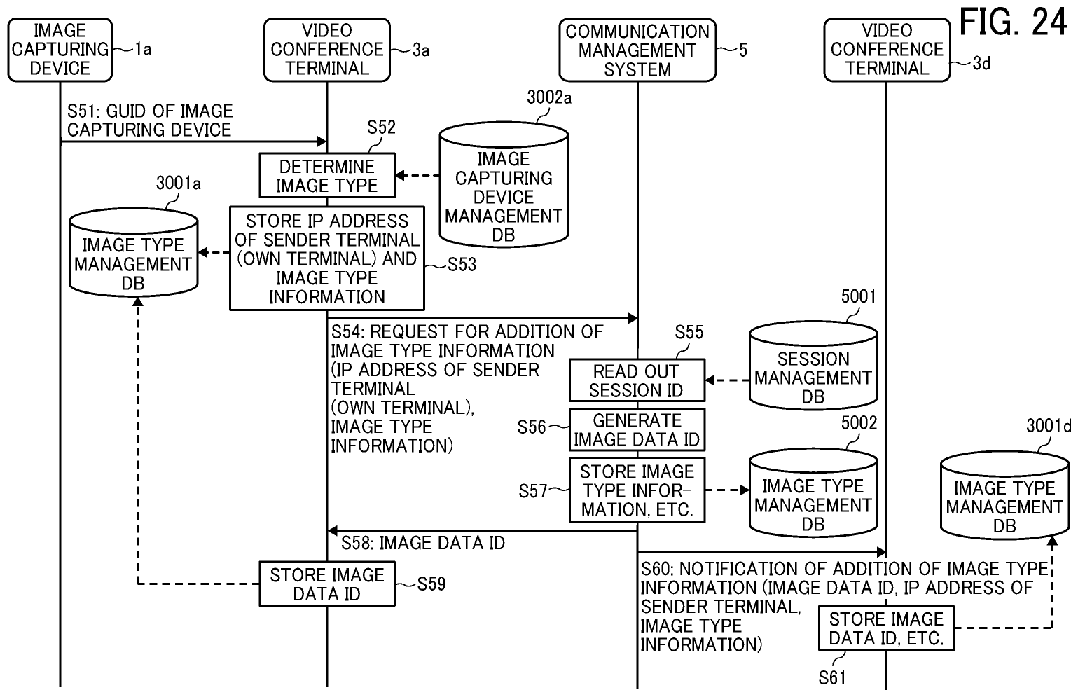

Referring to FIG. 22 and FIG. 23, an operation of participating in a specific communication session is described, according to the embodiment. FIG. 22 is a sequence diagram illustrating an operation of participating in a specific communication session, according to the embodiment. FIG. 23 is an illustration of a session selection screen for selecting a communication session (virtual conference room), according to the embodiment.

When a user in the base A (e.g., user A1) operates the videoconference terminal 3a to display the session selection screen for selecting a communication session (virtual conference room), the acceptance unit 32a receives the operation to display the session selection screen, and the display control unit 34a causes the display 4a to display the session selection screen as illustrated in FIG. 23 (step S21). In the session selection screen, selection buttons b1, b2, and b3 are displayed. The selection buttons b1, b2, and b3 respectively indicates virtual conference rooms R1, R2, R3, each of which is a selection target. Each of the selection buttons b1, b2, and b3 is associated with a corresponding session ID.

When the user A1 selects a desired selection button (in this example, the selection button b 1) on the session selection screen, the acceptance unit 32a receives selection of a corresponding communication session (step S22). Then, the data exchange unit 31a transmits a request to participate in the communication session, namely to enter the corresponding virtual conference room, to the communication management system 5 (step S23). This participation request includes a session ID identifying the communication session for which the selection is received at step S22, and the IP address of the videoconference terminal 3a, which is a request sender terminal. The communication management system 5 receives the participation request at the data exchange unit 51.

Next, the data storage/read unit 99 performs a process for causing the videoconference terminal 3a to participate in the communication session (step S24). More specifically, the data storage/read unit 59 adds, in the session management DB 5001 (FIG. 19), the IP address that is received at step S23 to a field of the participant terminal IP address in a record of the session ID that is the same as the session ID received at step S23. The data exchange unit 51 transmits a response to the participation request to the videoconference terminal 3a (step S25). This response to the participation request includes the session ID that is received in step S23, and a result of the participation process. The videoconference terminal 3a receives the response to the participation request at the data exchange unit 31a. The following describes a case where the operation for causing the videoconference terminal 3a to participate in the communication session, namely the participation process, is successfully completed.

<Operation of Managing Image Type Information>

Next, referring to FIG. 24, an operation of managing the image type information is described, according to the embodiment. FIG. 24 is a sequence diagram illustrating an operation of managing the image type information, according to the embodiment.

When a user (e.g., the user A1) in the base A connects the cradle 2a, on which the image capturing device 1a is mounted, to the videoconference terminal 3a, using a wired cable such as a USB cable, the data storage/read unit 19a of the image capturing device 1a reads out the GUID of the own device (e.g., the image capturing device 1a) from the memory 1000a. Then, the communication unit 18a transmits the own device's GUID to the communication unit 38 of the videoconference terminal 3a (step S51). The videoconference terminal 3a receives the GUID of the image capturing device 1a at the communication unit 38.

Subsequently, the determination unit 35a of the videoconference terminal 3a determines whether a vendor ID and a product ID same as the GUID received in step S51 are stored in the image capturing device management DB 3002a (see FIG. 17) to determine the image type (step S52). More specifically, the determination unit 35a determines that the image capturing device 1a is an image capturing device that captures a special image (a spherical panoramic image, in the embodiment), based on determination that the same vender ID and product ID are stored in the image capturing device management DB 3002a. By contrast, the determination unit 35a determines that the image capturing device 1a is an image capturing device that captures a general image, based on determination that the same vender ID and product ID are not stored in the image capturing device management DB 3002a.

Next, the data storage/read unit 39a stores, in the image type management DB 3001a (FIG. 16), the IP address of the own terminal (i.e., videoconference terminal 3a), which is a sender terminal, in association with the image type information, which is a determination result determined in step S52 (step S53). In this state, any image data D is not yet associated. Examples of the image type information include a source name, which is determined according to the naming rule, and an image type (general image or special image).

Then, the data exchange unit 31a transmits a request for addition of the image type information to the communication management system 5 (step S54). This request for addition of image type information includes the IP address of the own terminal (videoconference terminal 3) as a sender terminal, and the image type information, both being stored in step S53 in association with each other. The communication management system 5 receives the request for addition of the image type information at the data exchange unit 51.

Next, the data storage/read unit 59 of the communication management system 5 searches the session management DB 5001 (FIG. 19) using the IP address of the sender terminal received in step S54 as a search key, to read out the session ID associated with the IP address (step S55).

Next, the generator 56 generates a unique image data ID (step S56). Then, the data storage/read unit 59 adds, in the image type management DB 5002 (FIG. 20), a new record associating the session ID that is read out in step S55, the image data ID generated in step S56, the IP address of the sender terminal and the image type information that are received in step S54, with one another (step S57). The data exchange unit 51 transmits the image data ID generated in step S56 to the videoconference terminal 3a. The videoconference terminal 3a receives the image data ID at the data exchange unit 31a (step S58).

Next, the data storage/read unit 39a of the videoconference terminal 3a stores, in the image type management DB 3001a (FIG. 16), the image data ID received in step S58, in association with the IP address of the own terminal (i.e., videoconference terminal 3) as the sender terminal and the image type information that are stored in step S53 (step S59).

Further, the data exchange unit 51 of the communication management system 5 transmits a notification indicating addition of the image type information to another communication terminal (i.e., videoconference terminal 3d) (step S60). This notification indicating addition of the image type information includes the image data ID generated in step S56, and the IP address of the own terminal (i.e., videoconference terminal 3a) as the sender terminal and the image type information that are stored in step S53. The The videoconference terminal 3d receives the notification indicating addition of the image type information at the data exchange unit 31d. The destination of the notification transmitted by the data exchange unit 51 is indicated by an IP address associated with the session ID with which the IP address of the videoconference terminal 3a is associated in the session management DB 5001 (FIG. 19). In other words, the destination includes other communication terminal(s) that is (are) in the same virtual conference room where the videoconference terminal 3a is participating.

Next, the data storage/read unit 39d of the videoconference terminal 3d adds, in the image type management DB 3001 (FIG. 15), a new record associating the image data ID, the IP address of the sender terminal, and the image type information, which are received in step S60 (step S61). In substantially the same manner, the notification indicating addition of the image type information is transmitted to the smartphone 9 and the PC 7, which is one of the other communication terminals, and then the smartphone 9 and the PC 7 stores the image type information, etc. in the image type management DB 9001 and the image type management DB 7001 (FIG. 15). Through the operation as described above, the same information is shared among the communication terminals by being stored in the image type management DB 3001a, the image type management DB 3001d, the image type management DB 7001 and the image type management DB 9001.

<Communication Process of Captured Image Data>

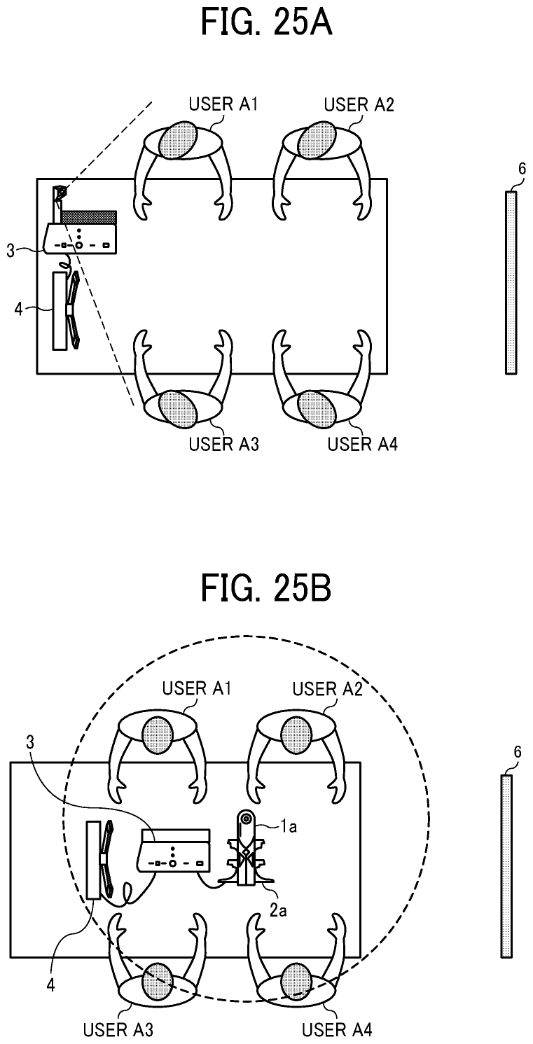

Next, referring to FIG. 25 to FIG. 35B, a description is given of a communication process of captured image data. FIG. 25 is illustrating an example state of video communication. FIG. 25A illustrates a case where the image capturing device 1a is not used, while FIG. 25B illustrates a case where the image capturing device 1a is used.

As illustrated in FIG. 25A, when the camera 312 (see FIG. 11), which is built into the videoconference terminal 3a, is used and the image capturing device 1a is not used, the videoconference terminal 3a has to be placed in a corner of a desk, so that the users A1 to A4 can be captured by the camera 312 having a field angle that is horizontally 125 degrees and vertically 70 degrees. This requires the users A1 to A4 to look in the direction of the videoconference terminal 3a while talking. Because the user A1 to A4 look in the direction of the videoconference terminal 3a, the display 4a also must be placed near the videoconference terminal 3a. This requires the user A2 and the user A4, who are away from the videoconference terminal 3a, to talk in a relatively loud voice, because they are away from the microphone 314 (FIG. 11) built in the videoconference terminal 3a. Further, the user A2 and A4 may find difficulty to see contents displayed on the display 4a.

In contrast, as illustrated in FIG. 25B, when the image capturing device 1a, which can obtain two hemispherical images, from which a spherical panoramic image is generated, is used, the videoconference terminal 3a and the display 4a can be placed relatively in the center of the desk. Comparing with the case where the image capturing device 1a is not used as illustrated in FIG. 25A, the users A1 to A4 can talk with a relatively low volume, because the users A1 to A4 is closer to the microphone 314. Further, it gets easier for the users A1 to A4 to see contents displayed on the display 4a. In addition, on the right side of the base A, a whiteboard 6 to which the user A1 and so on can write characters, pictures and so on is installed.

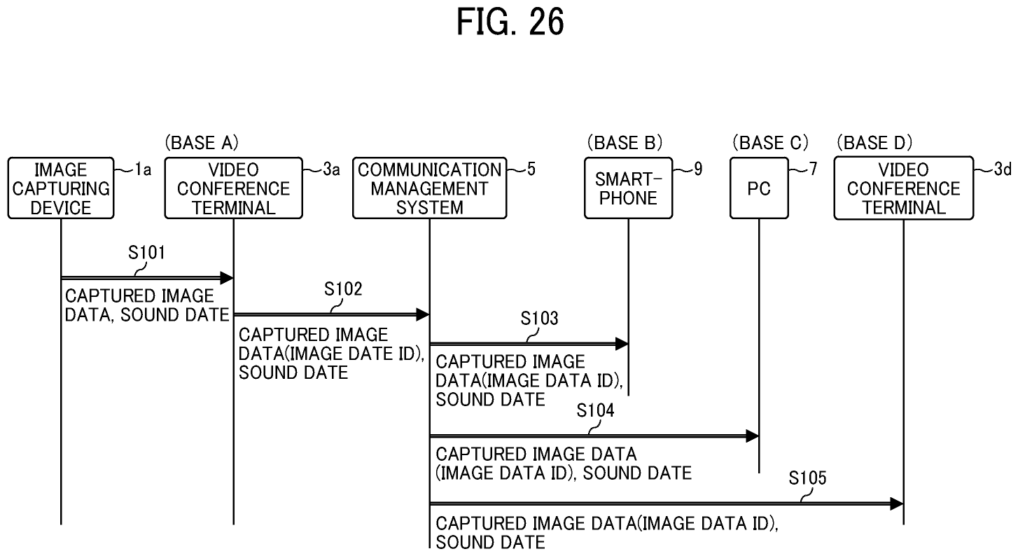

Subsequently, processing shown in FIG. 26 for transmitting the captured image data and sound data obtained at the base A shown in FIG. 25 (b) to each other communication terminals (Smartphone 9, PC 7, Video Conference Terminal 3d) via the communication management system 5 Will be explained. FIG. 26 is a sequence diagram showing communication processing of captured image data and sound data in a video call.

First, the communication unit 18a of the image capturing device 1a transmits image data obtained by capturing a subject, a landscape and so on and sound data acquired by collecting sound to the communication unit 38a of the video conference terminal 3a (step S101). Because the image capturing device 1a is a device that is configured to obtain two hemispherical images, from which a spherical panoramic image is generated, the image data is configured by data of the two hemispherical images as illustrated in FIG. 3A and FIG. 3B. The videoconference terminal 3a receives the image data at the communication unit 38a.

Next, the data exchange unit 31a of the videoconference terminal 3a transmits, to the communication management system 5, the image data and sound data received from the image capturing device 1a (S102). At step S102, along with the image data, an image data ID identifying the image data, which is a transmission target, is also transmitted. Thus, the communication management system 5 receives the image data and the image data ID, at the data exchange unit 51.

Next, the data exchange unit 51 of the communication management system 5 transmits the image data and the sound data to the communication terminal (smartphone 9, PC 7, video conference terminal 3d) participating in the same video call as the video conference terminal 3a. (S103, S104, S105). At step S103, S104 and S105, along with the image data, an image data ID identifying the image data, which is a transmission target is also transmitted. Thus, the data exchange unit 91 of the smartphone 9, the data exchange unit 71 of the PC 7 and the data exchange unit 31d of the video conference terminal 3d receive the image data, the image data ID and the sound data.

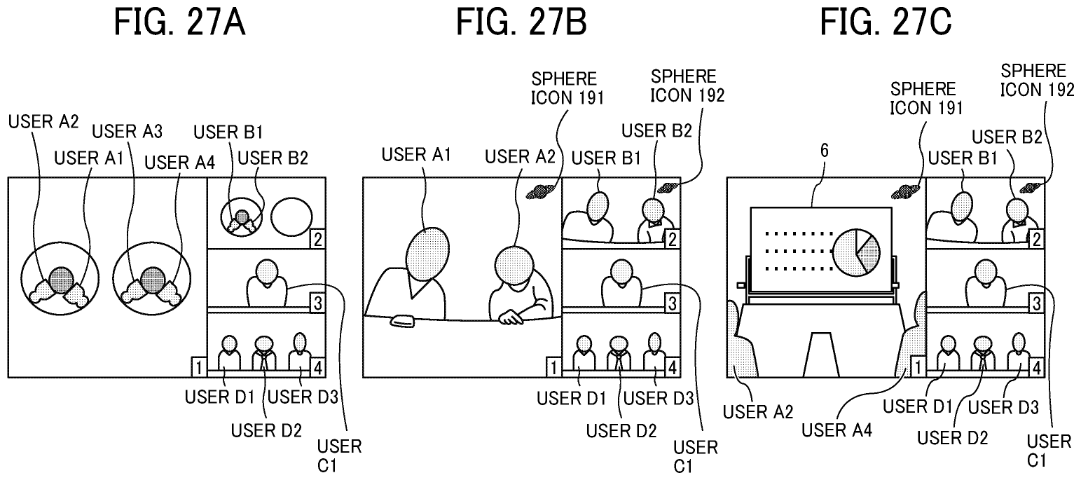

Next, referring to FIG. 27A, FIG. 27B and FIG. 27C, examples of a screen of the display 917 in the base D are described, according to the embodiment. FIG. 27 shows a display example of the display at the base D. Among these, FIG. 27 (a) shows the case of displaying as it is without creating a spherical panoramic image and a predetermined area image from the image data transmitted from the image capturing device 1a at the base A via the video conference terminal 3a and the image capturing device 1b at the base B. On the other hand, FIG. 27B shows the case of creating of the spherical panoramic image and the predetermined area image from the image data transmitted from the image capturing device 1a at the base A and the image capturing device 1b at the base B. The image of the base A is displayed in the display area (layout number “1”) on the left side of the display 917, and the image of the base B (own base) is displayed in the display area (layout number “2”) on the upper right side of the display 917. Further, the image of the base C is displayed in the display area (layout number “3”) on the middle right side of the display 917, and the image of the base D is displayed in the display area (layout number “4”) on the lower right side of the display 917. The layout number “1” is a main display area, and the layout number “2”, “3” and “4” are a secondary display area. It is possible to change the image of the main display area and the secondary display area at each terminal. The image of the base is usually displayed at the main display area of each base. The image of the base where there is a center person of video communication is usually displayed at the main display area of each base.

Here, if the image data transmitted from the capturing device 1a and 1b, which are configured to capture the spherical panoramic image, are displayed as it is, the images of the base A and the base B such as FIG. 27 (b) are displayed as the hemispherical images of a front side and rear side such as shown in FIG. 3 (a) and FIG. 3(b).

In contrast, if the image/audio processor 93 generates the both of spherical panoramic image and further the predetermined area image based on two hemispherical images, the predetermined area image which is the planer image is displayed as shown in FIG. 27(b). The general image (planer image) is displayed in FIGS. 27(a) and (b), because the capturing device 8 obtains the general image at the base C and the video conference terminal 3d obtains the general image at the base D. By this, the user A1 and the user A2 who are some users at the base A are displayed as the initial setting (default) such as FIG. 27(a) and FIG. 27(b).

Furthermore, a user of each base can change a predetermined area corresponding to the predetermined-area image in the same spherical panoramic image. For example, the acceptance unit 92 accepts an input for moving the predetermined area image corresponding to an operation of the touch panel by user B1 and the display control unit controls to shift, rotate, reduce or enlarge the predetermined area image displayed on the display. By this, the image controller 94 changes the image that the user A1 and the user A2, who are some users at the base A which are displayed as the initial setting (default) such as FIG. 27(a), to the predetermined area image such as shown in FIG. 27(c). Concretely, FIG. 27(c) shows that the image was changed from the predetermined area image, which included the user A1 and A2 at the base A such as FIG. 25(b), to the predetermined area image which includes the white board 6.

The sphere icon 191 and 192 are examples of the special image identification icon for the predetermined area image expressed by the predetermined area T which is a part of the sphere panoramic image. The display position of the sphere icon 191 and 192 may be anywhere, not upper right, upper left, lower left or lower right and so on. And, the kind of the sphere icon is not limited the icon described in FIGS. 27(b) and (c). Moreover, the special image identification icon may be not only the sphere icon 191 and 192 but also may be text that indicates “the sphere panoramic image” or the combination of the icon and the text.

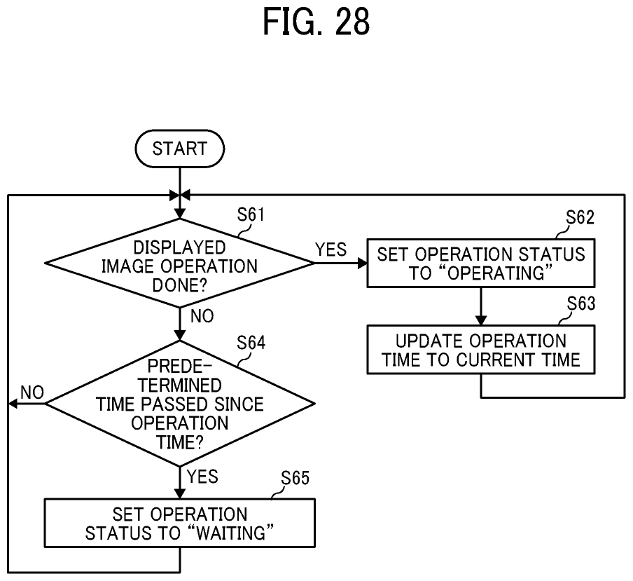

FIG. 28 shows a processing flow of the set operation status as an example with the smartphone 9.

At first, the determination unit 95 of the smartphone 9 determines whether there are the operations on the displayed image (view operation) to the sphere panoramic image during a session by the user. (S65) As an example of the determination, the determine unit 95 determines whether there is the touch operation by the user or an input operation on the touch panel 921 to select the displayed image (the view display area) by the user to the display area of “a predetermined are image (an example of a first predetermined area image) that is a partial area of the sphere panoramic image” of the determined target on the display of the smartphone 9.

At the result of the determining at S65, in the case that there is the view operation (Yes at S65), the setting unit 96 accesses the operate condition management DB 9004 and sets the operation status for the predetermined area image that is a partial area of the spherical panoramic image to “operating”. (S66)

Additionally, the setting unit 96 updates the operation time to a current time of the operate condition management DB 9004 (S67) and returns the process of S65. For example, the operation time may be recorded in the form of timestamp.

On the other hand, at the result of the determining at S65, in case there isn't the view operation (No at S68), the determination unit 95 determines whether the predetermined time has passed from final operation. (S68) As an example of the determining technique, the determination unit 95 obtains the operation time of the operate condition management DB 9004 and calculates the pass time from obtained the operation time to the current time.

At the result of the determining at S68, in case the pass time is within the predetermined time (No at S68), the process returns the process of S65. At the result of the determining at S68, in case the pass time is over the predetermined time (Yes at S68), the setting unit 96 sets the operation status of the operate condition management DB 9004 to “waiting” via the data storage/read unit 99. As an example, the predetermined time may be within three seconds, but it may not be limited to that time. The predetermined time may be previously set in the storage unit 9000 before shipment from the factory or set or changed afterwards.

This flow of the process may regularly be executed to every spherical panoramic image in every communication terminal which joins the communication session.

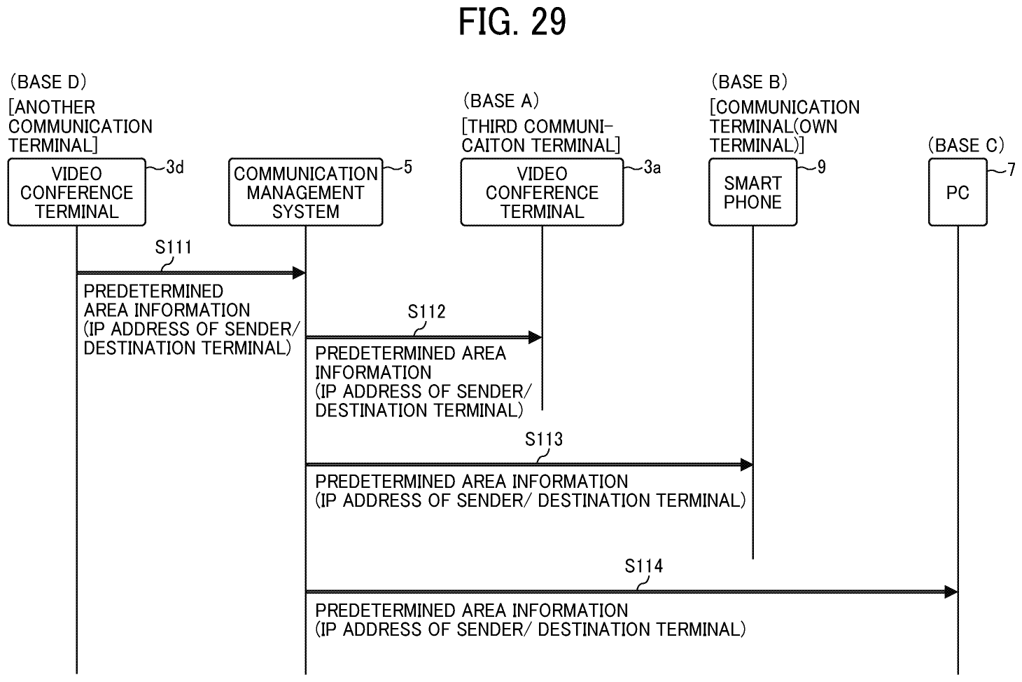

Then, FIG. 29 show the process of the image communication system in the case of displaying the predetermined area image such as FIG. 27(b) and in the case of changing the predetermined area image from FIG. 27(b) to FIG. 27(c). FIG. 29 is a sequence diagram which shows the process to share of the predetermined area information. In FIG. 29, the videoconference terminal 3a at the base A is the third communication terminal, the videoconference terminal 3d at the base D is another communication terminal and the smartphone 9 at the base B is the communication terminal (own terminal).

At first, as shown in FIG. 27(b), in the case of displaying a predetermined area image of the base A at the base D using the video conference terminal 3d by the user and so on, the data exchange unit 31d of the videoconference terminal 3d transmits predetermined area information indicating the displayed predetermined area image to the communication management system 5 (step S111). The predetermined area information includes the IP address of the video conference terminal 3a that is the sender of the captured image data, and the IP address of the video conference terminal 3d that is the transmission destination of the captured image data (the sender of the predetermined area information). Thereby, the data exchange unit 51 of the communication management system 5 receives the predetermined area information.

Next, the data exchange unit 51 distributes (transmits) the predetermined area information including each IP address received in step S111 to the other communication terminal (Video conference terminal 3a, Smartphone 9, PC 7) which is performing the same video communication (video calling) with the video conference terminal 3d which is the sender of the predetermined area information.

This flow process is performing every change of the predetermined area image such as from FIG. 27(b) to FIG. 27(c).

By the above, the predetermined area information indicates the predetermined image being changed in the base A and transmitted to every communication terminal which is performing the same video communication (video calling) in the other base B, C, D.

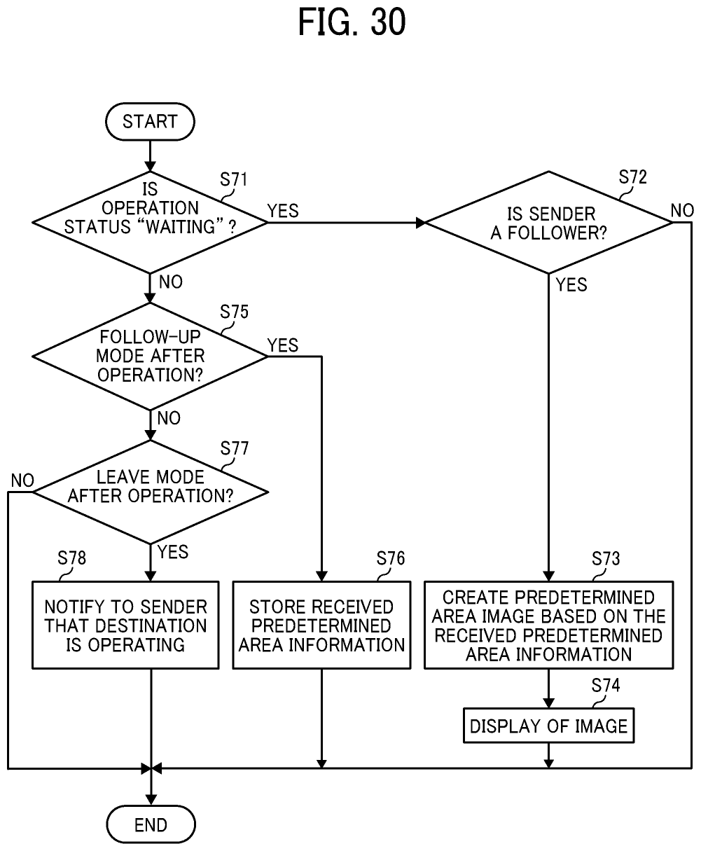

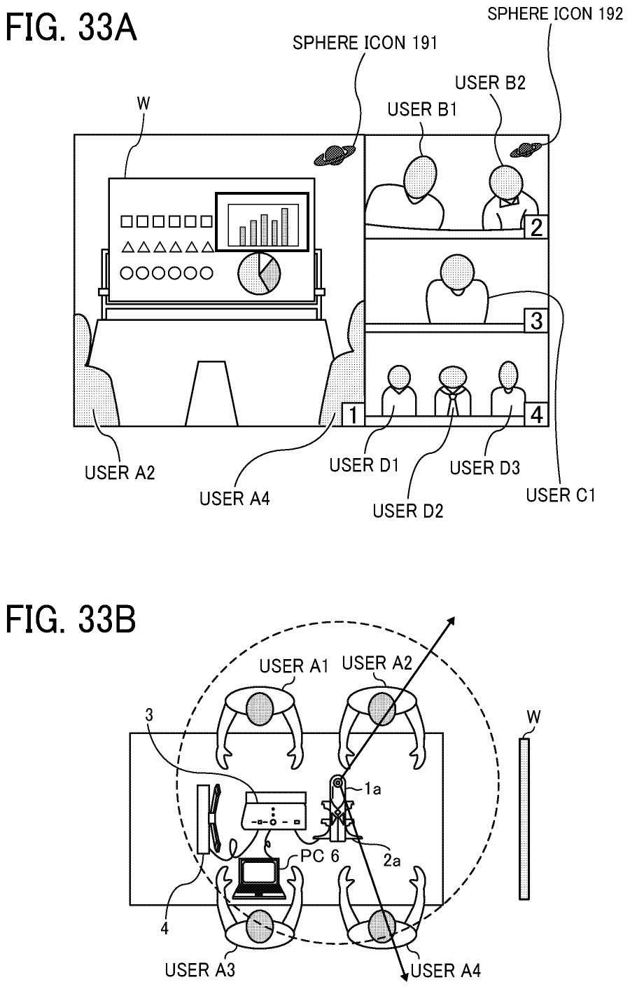

FIG. 30, FIG. 33A to FIG. 35B explains “the predetermined area information receive process” to be performed when the communication terminal (i.e., Smartphone 9) of each base, the base B as an example, receives the predetermined area information from the other communication terminal (i.e., Videoconference terminal 3a) of each base, the base A as an example.

FIG. 30 is a flowchart illustrating an operation of receiving of predetermined area information. Note that the processing flow shown in FIG. 30 is executed each time each communication terminal participating in the communication session receives predetermined area information from another communication terminal participating in the communication session.

FIG. 33A is a diagram showing the same display image as FIG. 27C in the base B. FIG. 33B is an image diagram showing the state of a video conference at the base A and It is the figure which showed the imaging range of the base A corresponding to the predetermined area region image which showed the state of the base A shown in FIG. 33 with the arrow.

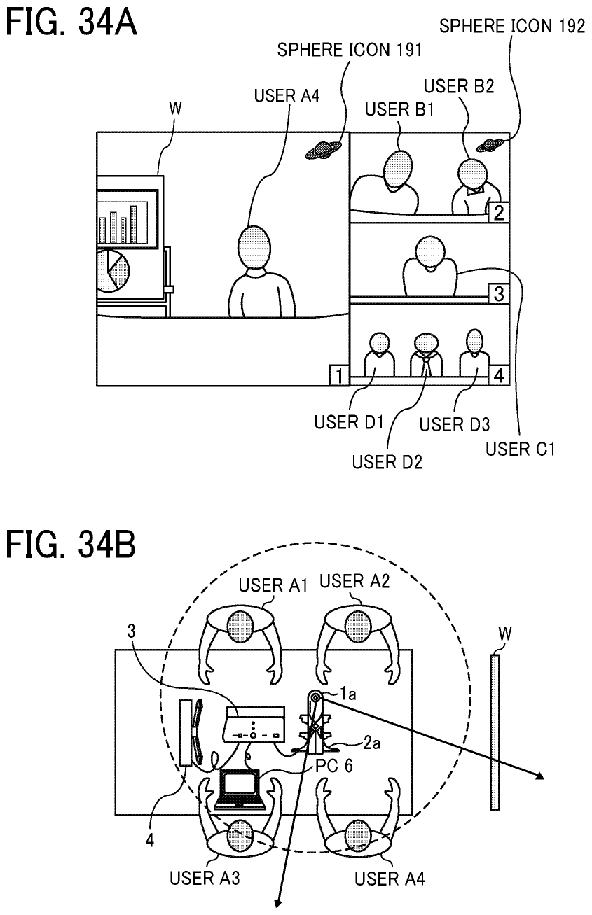

FIG. 34A is a view showing a display image after a change operation is performed on the predetermined area image showing the state of the base A in FIG. 33A. FIG. 34B is an image diagram showing the state of a video conference at the base A.

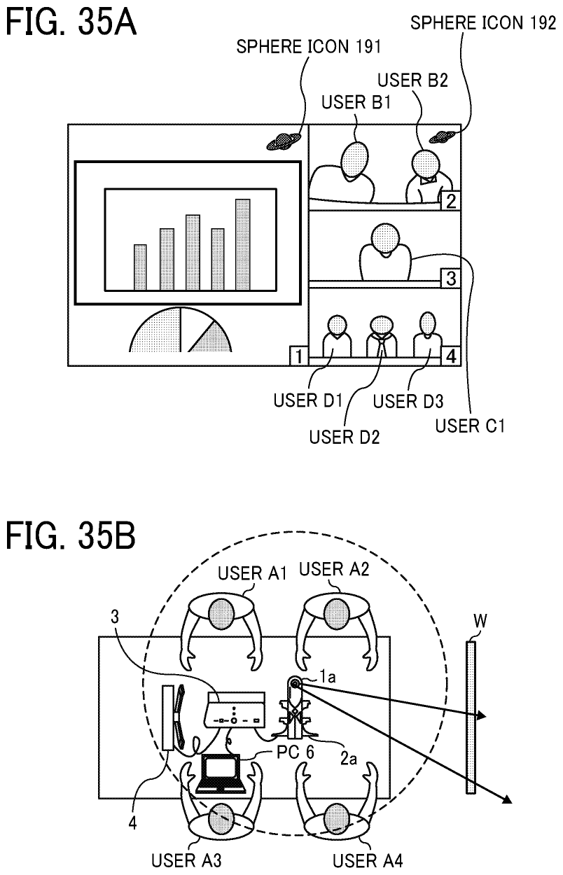

FIG. 35A is an illustration showing a display image including a predetermined area image based on the predetermined area information sent from the communication terminal at the base A.

FIG. 35B is an image diagram showing the state of the video conference at the base A. and It is the illustration which showed the imaging photography range of the base A corresponding to the predetermined area region image which showed the mode of the base A shown to FIG. 35A with the arrow.

At first, the determination unit 95 of the smartphone 9 determines whether the operation status of the own base to predetermined area image being displayed is “WAITING”. (S71) The determination unit 95 can determine the operation status to refer the operate condition management DB 9004 via the data storage/read unit 99. The determination unit 95 may determine whether the target image data is operated at that time.

In the case that the determined result of step S71 is “WAITING” (in the case of YES), the determination unit 95 determines whether the video conference terminal 3a which is the sender terminal of predetermined area information is the follower (reflection base). (S72) The determination unit 95 can determine if the video conference terminal 3a is the follower by referring to whether there is a setting of the reflecting base type set for the video conference terminal 3a. Specifically, the data storage/read unit 99 refers to the display mode of the display mode management DB 3003a using the transmission source IP address, which is the identification information of the sender terminal of the predetermined area information, as a search key and if the display mode is not “leave mode”, the determination unit 95 determines that the video conference terminal 3a that is the sender terminal is the follower. If the display mode is “leave mode”, the determination unit 95 determines that the video conference terminal 3a that is the sender terminal is not the follower.

In the result of determining step S72, when the video conference is the follower, the image/audio processor 93 generate the predetermined area image by using the pending parameter to be set (S73), the display control unit 94 controls to display 917 the predetermined area image to be generated (S74), this process flow finishes.

Like this way, the smartphone 9 which is the communication terminal reflects the predetermined area image as a display image of the own base based on the predetermined area information to be received from the video conference terminal 3a which is the other communication terminal.

Here, a specific screen transition when the process of step S74 is performed will be described. This process is executed when it is not the “leave mode” shown in FIG. 18. For example, as shown in FIG. 33A, when a predetermined area image indicating the state of each base is displayed at the base B and the predetermined area information is transmitted from the video conference terminal 3a at the base A to the smartphone 9 at the base B, the smartphone 9 changes the display image of the display area (layout number “1”) on the video conference terminal 3a as shown in FIG. 35A to the same display image as the current display image.

On the other hand, in the result of determination of step S72, when the video conference terminal 3a isn't the follower (in the case of NO), this process flow finishes. In this case, the smartphone 9 displays the displayed display image as it is. For example, as shown in FIG. 33A, when a predetermined area image indicating the state of each base is displayed at the base B, the same display image is displayed as it is.

Return to the determination step S71, when the result of step S71 isn't “WAITING” (in the case of NO), the determination unit 95 determines whether the sender terminal of the predetermined area information is “Follow-up mode after operation” (S75). Specifically, the storage/reading unit 99 refers to the display mode of the display mode management DB 9003 using the transmission source IP address that is identification information of the transmission source of the predetermined area information as a search key and the determination unit 95 determines whether or not the follow-up mode after operation is set.

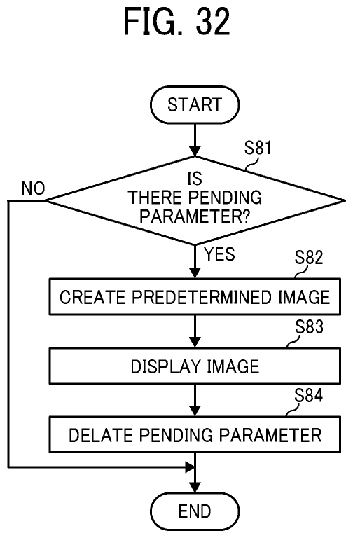

In the result of determination of step S75, in the case of the follow-up mode after operation (in the case of YES), the setting unit 96 store the display parameter which is included the predetermined area information to be received as a pending parameter of the operate condition management DB 9004 via the data storage/read unit 99 (S76), this process flow finishes. In this case, the smartphone 9 gives priority to the operation of the display image on its own terminal (smartphone 9), but after the operation, the smartphone 9 displays the predetermined area image (an example of the second predetermined area image) indicated by the predetermined area information received during the operation. The post-operation display process in the follow-up mode after operation will be described later with reference to FIG. 32.

In the result of step S75, when the sender terminal isn't the follow-up mode after operation (in the case of NO), the determination unit 95 determines whether the sender terminal is “leave mode after operation” (S77). Specifically, the storage/reading unit 99 refers to the display mode of the display mode management DB 9003 using the transmission source IP address that is identification information of the transmission source of the predetermined area information as a search key and the determination unit 95 determines whether or not the leaving mode after operation is set.

In the result of step S77, when the sender terminal isn't “leave mode after operation” (in the case of NO), this process flow finishes. In this way, when the sender terminal of the predetermined area information isn't “follower” (in the case of NO at both step S75 and step S76), the smartphone 9 doesn't display the predetermined area image (Example of second predetermined area image) to be received the predetermined area information and The smartphone 9 displays the predetermined area image (an example of the first predetermined area image) that has already been displayed.

In the result of step S77, when the sender terminal is the “leave mode after operation” (in the case of YES), since the user of the smartphone 9 is operating the corresponding view (an example of the first predetermined area image), the data exchange unit 91 transmits a predetermined message indicating that the predetermined area image (an example of the second predetermined area image) is not displayed based on the predetermined area information transmitted from the video conference terminal 3a to the sender terminal (S78), and this process flow finishes. In this case, the smartphone 9 gives priority to the operation of the display image on the own terminal (smartphone 9), however after the operation, the last predetermined area image displayed during the operation remains displayed.

Here, a specific screen transition when the process of step S78 is performed will be described. This process is executed in the “leave mode after operation” shown in FIG. 18. When the user B1 at the site B operates the display area (layout number “1”), the predetermined area image is displayed shown in FIG. 34A, and the predetermined area information was transmitted from the video conference terminal 3a at the base A to the smartphone 9, the smartphone 9 gives priority to the display of the predetermined area image shown in FIG. 34A. After that, the smartphone 9 does not follow the predetermined area information transmitted from the video conference terminal 3a, and keeps the display of the predetermined area image shown in FIG. 34A.

Note that the predetermined message may not indicate that an operation is being performed on a display image (including a display image and an image that is not displayed) but may indicate that an operation is being performed on a panoramic image.

Further, as a reason for not following (reflecting) the predetermined area image, the smartphone 9 may notify the video conference terminal 3a that is the sender terminal of the predetermined area information that the display image is being operated on the smartphone 9 by transmitted a predetermined message. Thereby, there is an effect that the convenience of the image communication system can be improved. The transmission of the predetermined message may be notified as a display message on the captured image data of the video conference terminal 3a via the communication management system 5 or may be directly transmitted to the sender terminal IP address by other means such as e-mail. The content of the predetermined message may indicate that the display image (an example of the first predetermined area image) is being operated or may indicate that an operation is being performed on the omnidirectional panoramic image.

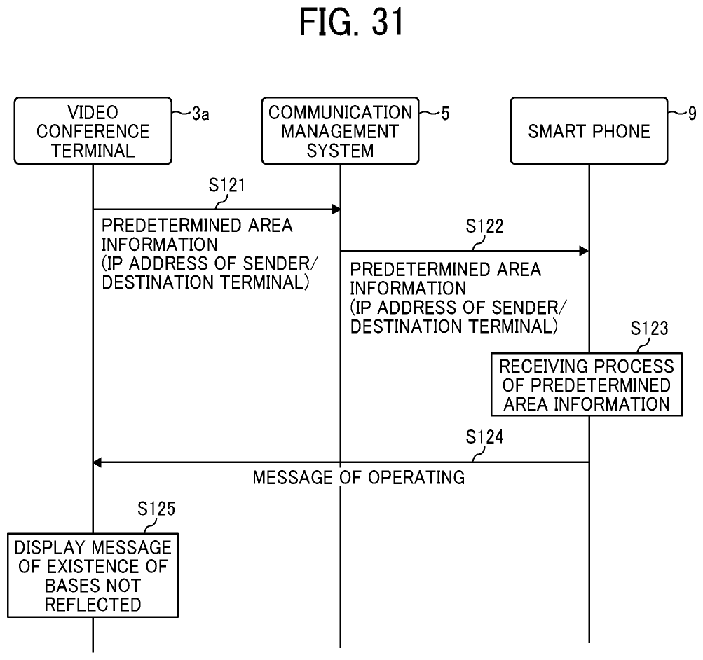

Here, FIG. 31 explains about a communication process of transmitting of predetermined message. FIG. 31 shows an example of the smartphone 9 as the communication terminal, the video conference terminal 3a is the other communication terminal which transmits the predetermined area information. And the video conference terminal 3a is a reflect base for the smartphone 9 and is especially the “leave mode after operation”.

At first, as described in FIG. 29, the video conference terminal 3a transmits the predetermined area information to the communication management system 5 (S121), the communication management system 5 that received the predetermined area information transmits the predetermined area information to the smartphone 9 (S122). The smartphone 9 operates the receiving process of predetermined area information as explained in FIG. 30 (S123). In FIG. 30, the step S71 is NO because of operating the smartphone 9, the step S75 is NO because the video conference terminal 3a is the “leave mode after operation”. In that result, the smartphone 9 transmits the above predetermined message. (S124) Then the display control unit 34a of the video conference terminal 3a that received the predetermined message displays the predetermined message. (S125)

The predetermined message is that “There is the communication terminal which doesn't follow the change of the predetermined image of the own base (the video conference terminal 3a) because of operating the display image (an example of the first predetermined area image)” and so on. However, it is not limited to this message. For example, the predetermined message may indicate that the user of the smartphone 9 is operating on the display image (an example of the first predetermined area image), and may indicated that the predetermined area image (an example of the second predetermined area image) based on the predetermined area information transmitted from the video conference terminal 3a, is not displayed. Further, the smartphone 9 may transmit information indicating the transmission source of the predetermined message (the IP address of the smartphone, the base name, etc.) in the predetermined message. Thereby, the user of the video conference terminal 3a which is the sender terminal may grasp which communication terminal is not following the display screen.

The predetermined message may be stored in advance in the memory 3000a, may be created before transmission, or may be changed as appropriate.

Also, in FIG. 31 the smartphone 9 directly transmits the message to the video conference terminal 3a, but the smartphone 9 may transmit the message to the video conference terminal 3s via the communication management system 5.

Furthermore, although FIG. 31 explains the case where the video conference terminal 3a received a predetermined message from the smart phone 9, the video conference terminal 3a may receive and display the predetermined message transmitted from the communication terminal of bases other than the smart phone 9.

Furthermore, FIG. 31 explains the case where the video conference terminal 3a received a predetermined message from the smart phone 9, the video conference terminal 3a may receive and display the predetermined message transmitted from the communication terminal of bases other than the smart phone 9. Therefore, the video conference terminal 3a which is the other terminal to transmit the predetermined area information may notice whether each user of the every destination terminal browses the changed predetermined area image.

Next, FIG. 32 explains the process after transition of the operation status.

At first, the data storage/read unit 99 refers to the operate condition management DB 9004 by using the IP address of the sender terminal of the sphere panoramic image and the determination unit 95 determines whether a value of the pending parameter is set. (S81) In the determine result of step S81, when the pending parameter isn't set (in the case of NO), this process flow finishes.

On the other hand, in the determine result of step S81, when the pending parameter is set (in the case of YES), Because of follow-up mode after operation, the image/audio processor 93 generates the predetermined area image by using the value of the set pending parameter (S82), the display control unit 94 displays the generated predetermined area image. (S83) Step S83 and step S84 may be called the reflect process. Like this, the communication terminal reflects the predetermined area image based on the received predetermined area information from the other communication terminal as a display image of own base after the status of “operating” transition the status of “waiting”.

The setting unit 96 deletes the pending parameter which was used to generate the predetermined area image (S84), and this process flow finishes.

This process flow may be performed for each spherical panoramic image for which the operation status transitioned to “waiting” in each communication terminal participating in the communication session.

Here, a specific screen transition when the process of step S83 is performed will be described.

This process is executed in the “follow-up mode after operation” shown in FIG. 18. When the user B1 at the site B operates the display area (layout number “1”), the predetermined area image is displayed shown in FIG. 34A, and the predetermined area information was transmitted from the video conference terminal 3a at the base A to the smartphone 9, the smartphone 9 gives priority to the display of the predetermined area image shown in FIG. 34A. After that, as shown in FIG. 35A, the smartphone 9 changes the display image of the display area (layout number “1”) to the same as the display image displayed on the video conference terminal 3a.

As above, the user at the base B can display as the own base image data of image area in the other base, display the display image on the own base by giving priority to the operation at the own base on the display image. This has the effect of improving the operability of image display for the user.

### SUPPLEMENT

In the above-described embodiment, the three-dimensional panoramic image has been described as the captured image (whole image) as an example of the panoramic image, but it may be a two-dimensional panoramic image.

In the above embodiment, the communication management system 5 relays the predetermined area information transmitted from each communication terminal. However, the present invention is not limited to this, and the communication terminals may directly transmit and receive the predetermined area information.

Also, each function of the above embodiments can be realized by one or more processing circuits. Here, the “processing circuit” or “processing circuitry” in the present specification is designed to execute a processor programmed to execute each function by software like a processor implemented by an electronic circuit, and to execute each function described above. A device such as an application specific integrated circuit (ASIC), a digital signal processor (DSP), a field programmable gate array (FPGA), a system on a chip (SOC), a graphics processing unit (GPU), or a conventional circuit module is included.

1. A communication terminal for displaying a first predetermined image of a first predetermined area in a whole image shared with another communication terminal, the communication terminal comprising:
processing circuitry configured to
receive a predetermined area information indicating a second predetermined area transmitted by another communication terminal displaying a second predetermined area image of the second predetermined area in the whole image; and
control displaying of the second predetermined area image indicated by the received predetermined area information based on an operation status with respect to the first predetermined area image when the predetermined area information is received.

2. The communication terminal of claim 1, wherein
the processing circuitry is configured to
manage an association of a terminal identification information of the other communication terminal with a display mode which indicates whether or not the second predetermined area image indicating the received predetermined area information is displayed and reflected on the communication terminal among other communication terminals, and
store the received predetermined area information, when the terminal identification information is managed associated with a follow-up mode after operation, and the operation status when the predetermined area information is received is in operation.

3. The communication terminal of claim 2, wherein
the processing circuitry is configured to control to display the second predetermined area image indicated by the stored predetermined area information when the operation status changes to a waiting state, which is a state indicating that the communication terminal is not in operation.

4. The communication terminal of claim 1, wherein
the processing circuitry is configured to transmit a notification that the communication terminal is currently in operation to the other communication terminal, when the terminal identification information is managed in association with a leave mode after operation, and the operation status when the predetermined area information is received is that the communication terminal is in operation.

5. The communication terminal of claim 1, wherein
the processing circuitry is configured to control to display the second predetermined area image indicated by the received predetermined area information when the terminal identification information is managed in association with the display mode, and the operation status when the predetermined area information is received is that the communication terminal is in a waiting state, which is a state indicating that the communication terminal is not in operation.

6. The communication terminal of claim 1, wherein
the whole image is a spherical panoramic image.

7. The communication terminal of claim 1, wherein
the communication terminal is one of a video conference terminal, a PC, a smartphone, a digital TV, a smart watch or a car navigation system.

8. The image communication system comprising:
a communication terminal configured to display a first predetermined image of a first predetermined area in a whole image shared with another communication terminal, the communication terminal including:
a processing circuitry configured to
receive predetermined area information indicating the second predetermined area transmitted by another communication terminal displaying the second predetermined area image of the second predetermined area in the whole image, and
control displaying of the second predetermined area image indicating by the received predetermined area information based on an operation status with respect to the first predetermined area image when the predetermined area information is received;
the other communication terminal; and
a communication management system configured to manage the image data communication between the communication terminal and the other communication terminal.

9. The image communication system according to claim 8, wherein the processing circuitry of the communication terminal is configured to transmit a notification that the communication terminal is currently in operation to the other communication terminal, when the terminal identification information is managed in association with a leave mode after operation, and the operation status when the predetermined area information is received is that the communication terminal is in operation.

10. The image communication system according to claim 9, wherein
the other communication terminal includes processing circuitry configured to display a message to indicate not to display the second predetermined area image according to the received predetermined area information because of the received notification.

11. A method implemented by a communication terminal configured to display a first predetermined image of a first predetermined area in a whole image shared with another communication terminal, the method comprising:
receiving, by processing circuitry, predetermined area information indicating the second predetermined area transmitted by another communication terminal displaying the second predetermined area image of the second predetermined area in the whole image; and
controlling, by the processing circuitry, displaying of the second predetermined area image indicated by the received predetermined area information based on an operation status with respect to the first predetermined area image when the predetermined area information is received.

12. The method of claim 11, further comprising:
managing an association of a terminal identification information of the other communication terminal with a display mode which indicates whether or not the second predetermined area image indicating the received predetermined area information is displayed and reflected on the communication terminal among other communication terminals; and
storing the received predetermined area information, when the terminal identification information is managed associated with a follow-up mode after operation, and the operation status when the predetermined area information is received is in operation.

13. The method of claim 12, further comprising:
controlling to display the second predetermined area image indicated by the stored predetermined area information when the operation status changes to a waiting state, which is a state indicating that the communication terminal is not in operation.

14. The method of claim 11, further comprising:
transmitting a notification that the communication terminal is currently in operation to other communication terminal, when the terminal identification information is managed in association with a leave mode after operation, and the operation status when the predetermined area information is received is that the communication terminal is in operation.

15. The method of claim 11, further comprising:
controlling to display the second predetermined area image indicated by the received predetermined area information when the terminal identification information is managed in association with the display mode, and the operation status when the predetermined area information is received is that the communication terminal is in a waiting state, which is a state indicating that the communication terminal is not in operation.

16. The method of claim 11, wherein
the whole image is a spherical panoramic image.

17. The method of claim 11, wherein
the communication terminal is one of a videoconference terminal, a PC, a smartphone, a digital TV, a smart watch or a car navigation system.
